(19) United States
(12) Patent Application Publication
(10) Pub. No.: US 2025/0298570 A1
(43) Pub. Date: Sep. 25, 2025

(54) TASK SUPPORT SYSTEM AND TASK SUPPORT METHOD

(71) Applicant: KABUSHIKI KAISHA TOSHIBA, Tokyo (JP)

(72) Inventors: Hiroki SHINAGAWA, Yokohama Kanagawa (JP); Sumire NISHIJIMA, Kodaira Tokyo (JP); Yukino MASUI, Yokohama Kanagawa (JP); Ren YAMASHITA, Yokohama Kanagawa (JP); Takanori YOSHII, Kawasaki Kanagawa (JP); Kyotaro HAYASHI, Yokohama Kanagawa (JP); Hiroaki NAKAMURA, Kawasaki Kanagawa (JP); Yoshiyuki HIRAHARA, Mishima Shizuoka (JP); Masamitsu FUKUDA, Yokohama Kanagawa (JP); Takafumi KOZAKAI, Ota Tokyo (JP); Yasuo NAMIOKA, Nerima Tokyo (JP)

(21) Appl. No.: 19/060,446

(22) Filed: Feb. 21, 2025

(30) Foreign Application Priority Data
Mar. 22, 2024 (JP) 2024-046990

(51) Int. Cl. G06F 3/14; B25B 23/142

(52) U.S. Cl. CPC G06F 3/1423; B25B 23/1425

(57) ABSTRACT

According to one embodiment, a task support system is configured to support a task for a plurality of fastening locations of an article present in a real space. The task support system includes a first display device and a second display device configured to display virtual objects to overlap the real space. Each of the plurality of fastening locations is assigned to one of a plurality of groups. The first display device displays a first virtual object for a first fastening location included in a first group, the first group being one of the plurality of groups. The second display device displays a second virtual object for a second fastening location included in a second group, the second group being another one of the plurality of groups.

### CROSS-REFERENCE TO RELATED APPLICATIONS

This application is based upon and claims the benefit of priority from Japanese Patent Application No. 2024-046990, filed on Mar. 22, 2024; the entire contents of which are incorporated herein by reference.

### FIELD

Embodiments of the invention generally relate to a task support system and a task support method.

### BACKGROUND

Conventionally, a display device that is wearable by a worker has been used to perform an efficient task. The display device can provide various information to the worker by displaying a virtual space to overlap real space. The worker can perform the task more efficiently by referring to the information displayed by the display device. Technology that can support a task performed by multiple workers using display devices is desirable.

### BRIEF DESCRIPTION OF THE DRAWINGS

FIG. 1 is a schematic view showing a configuration of a task support system according to an embodiment;

FIG. 2 is a schematic view illustrating a display device according to the embodiment;

FIG. 3 is a schematic view illustrating a task;

FIG. 4 is a plan view showing an article on which the task is performed;

FIG. 5 is a schematic view illustrating the task;

FIG. 6 is a schematic view showing an output example of the display device according to the embodiment;

FIG. 7 is a schematic view illustrating master data that is referenced according to the embodiment of the invention;

FIG. 8 is a table illustrating fastening location master data;

FIG. 9 is a plan view showing the article on which the task is performed;

FIGS. 10A and 10B are schematic views showing output examples of the display device according to the embodiment;

FIGS. 11A and 11B are schematic views showing output examples of the display device according to the embodiment;

FIGS. 12A and 12B are schematic views showing output examples of the display device according to the embodiment;

FIGS. 13A and 13B are schematic views showing output examples of the display device according to the embodiment;

FIG. 14 is a schematic view showing a specific example of a virtual object;

FIGS. 15A and 15B are schematic views showing output examples of the display device according to the embodiment;

FIGS. 16A and 16B are schematic views showing output examples of the display device according to the embodiment;

FIGS. 17A and 17B are schematic views illustrating a task;

FIG. 18 is a schematic view showing an example of a tool;

FIG. 19 is a schematic view showing a task;

FIG. 20 is a schematic view for describing calculation methods according to a first embodiment of the invention;

FIGS. 21A and 21B are schematic views for describing the calculation methods according to the first embodiment of the invention;

FIG. 22 is a schematic view for describing the calculation methods according to the first embodiment of the invention;

FIG. 23 is a schematic view for describing the calculation methods according to the first embodiment of the invention;

FIG. 24 is a schematic view illustrating a task;

FIG. 25A is a bottom view showing an article on which the task is performed, and FIG. 25B is a plan view showing the article on which the task is performed;

FIGS. 26A and 26B are schematic views showing output examples of the display device according to the embodiment;

FIGS. 27A and 27B are schematic views showing output examples of the display device according to the embodiment;

FIGS. 28A and 28B are schematic views showing output examples of the display device according to the embodiment;

FIG. 29 is a flowchart showing a task support method according to the embodiment;

FIG. 30 is a schematic view showing a configuration of another task support system according to the embodiment;

FIGS. 31A and 31B are schematic views showing configurations of other task support systems according to the embodiment; and

FIG. 32 is a schematic view showing a hardware configuration.

### DETAILED DESCRIPTION

According to one embodiment, a task support system is configured to support a task for a plurality of fastening locations of an article present in a real space. The task support system includes a first display device and a second display device configured to display virtual objects to overlap the real space. Each of the plurality of fastening locations is assigned to one of a plurality of groups. The first display device displays a first virtual object for a first fastening location included in a first group, the first group being one of the plurality of groups. The second display device displays a second virtual object for a second fastening location included in a second group, the second group being another one of the plurality of groups.

Embodiments of the invention will now be described with reference to the drawings. The drawings are schematic or conceptual; and the relationships between the thicknesses and widths of portions, the proportions of sizes between portions, etc., are not necessarily the same as the actual values thereof. The dimensions and/or the proportions may be illustrated differently between the drawings, even in the case where the same portion is illustrated. In the drawings and the specification of the application, components similar to those described thereinabove are marked with like reference numerals, and a detailed description is omitted as appropriate.

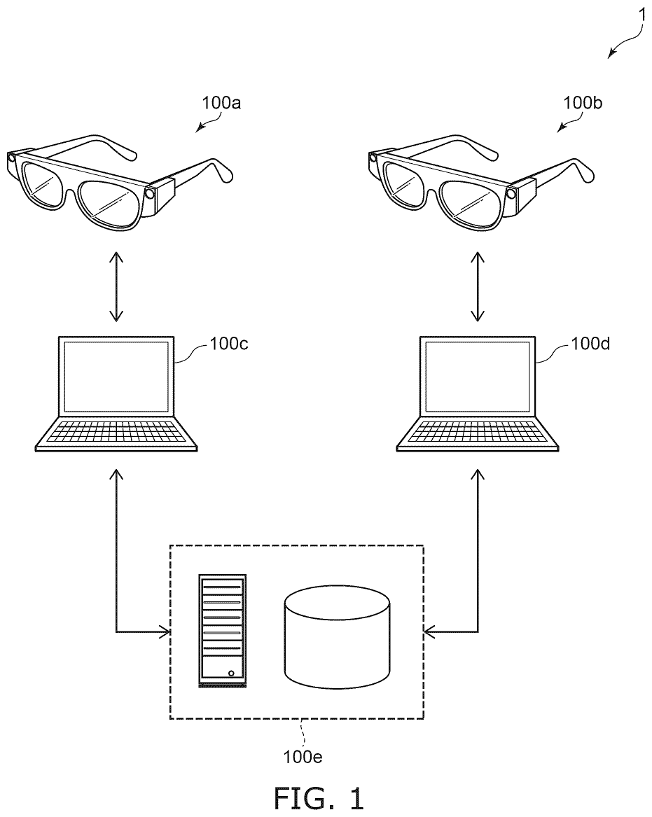

FIG. 1 is a schematic view showing a configuration of a task support system according to an embodiment.

The task support system 1 according to the embodiment is used to support a task. As shown in FIG. 1, the task support system 1 includes a display device 100a (a first display device) and a display device 100b (a second display device). In the illustrated example, the task support system 1 further includes a terminal device 100c, a terminal device 100d, and a host computer 100e.

The display device 100a is mounted to a worker performing a task. The display device 100a is connected with the terminal device 100c by wireless communication. Data related to the task is communicated between the display device 100a and the terminal device 100c. The display device 100b is mounted to another worker performing the task. The display device 100b is connected with the terminal device 100d by wireless communication. Data related to the task is communicated between the display device 100b and the terminal device 100d. The terminal device 100c and the terminal device 100d are connected with the host computer 100e via wired communication, wireless communication, or a network. The host computer 100e communicates data related to the task with the terminal devices 100c and 100d.

In the example shown in FIG. 1, the task support system 1 includes two display devices. The task support system 1 may include three or more display devices. An example will now be described in which the task support system 1 includes two display devices. In the following description, when the display device 100a and the display device 100b are not particularly differentiated, at least one of the display device 100a or the display device 100b is called simply the “display device 100”.

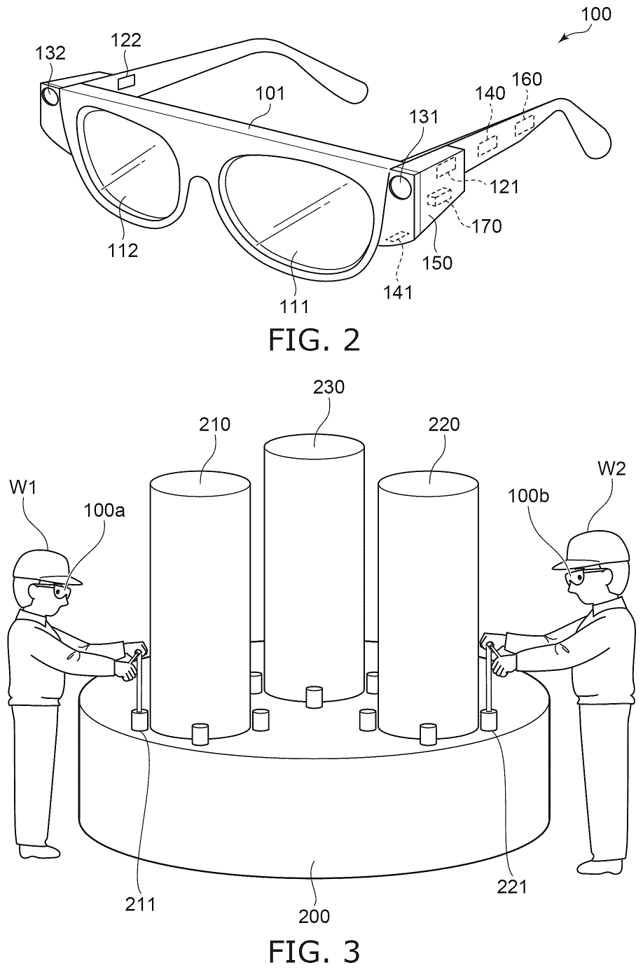

FIG. 2 is a schematic view illustrating the display device according to the embodiment.

As shown in FIG. 2, the display device 100 includes, for example, a frame 101, a lens 111, a lens 112, a projection device 121, a projection device 122, an image camera 131, a depth camera 132, a sensor 140, a microphone 141, a processing device 150, a battery 160, and a storage device 170.

In the illustrated example, the display device 100 is a binocular head mounted display. Two lenses, i.e., the lens 111 and the lens 112, are fit into the frame 101. The projection device 121 and the projection device 122 respectively project information onto the lenses 111 and 112.

The projection device 121 and the projection device 122 display a recognition result of a body of a worker, a virtual object, etc., on the lenses 111 and 112. Only one of the projection device 121 or the projection device 122 may be included; and information may be displayed on only one of the lens 111 or the lens 112.

The lens 111 and the lens 112 are light-transmissive. The wearer of the display device 100 can visually recognize reality via the lenses 111 and 112. Also, the wearer of the display device 100 can visually recognize the information projected onto the lenses 111 and 112 by the projection devices 121 and 122. Information (virtual space) is displayed to overlap real space by being projected by the projection devices 121 and 122.

The image camera 131 detects visible light and obtains a two-dimensional image. The depth camera 132 irradiates infrared light and obtains a depth image based on the reflected infrared light. The sensor 140 is a six-axis detection sensor and is configured to detect angular velocities in three axes and accelerations in three axes. The microphone 141 accepts an audio input.

The processing device 150 controls components of the display device 100. For example, the processing device 150 controls the display by the projection devices 121 and 122. The processing device 150 detects movement of the visual field based on a detection result of the sensor 140. The processing device 150 changes the display by the projection devices 121 and 122 according to the movement of the visual field. The processing device 150 also is configured to perform various processing by using data obtained from the image camera 131 and the depth camera 132, data of the storage device 170, etc.

The battery 160 supplies power necessary for the operations to the components of the display device 100. The storage device 170 stores data necessary for the processing of the processing device 150, data obtained by the processing of the processing device 150, etc. The storage device 170 may be located outside the display device 100, and may communicate with the processing device 150.

The display device 100 is not limited to the illustrated example, and may be a monocular head mounted display. The display device may be an eyeglasses-type as illustrated, or may be a helmet-type.

The worker uses a tool to tighten or loosen screws of an article. Hereinafter, tightening a screw and loosening a screw are called turning a screw. The article is a part, a unit, a semifinished product, etc., for making a product. The tool is a wrench, a screw driver, etc. Herein, an example is mainly described in which embodiments of the invention are applied to a fastening task of tightening a screw.

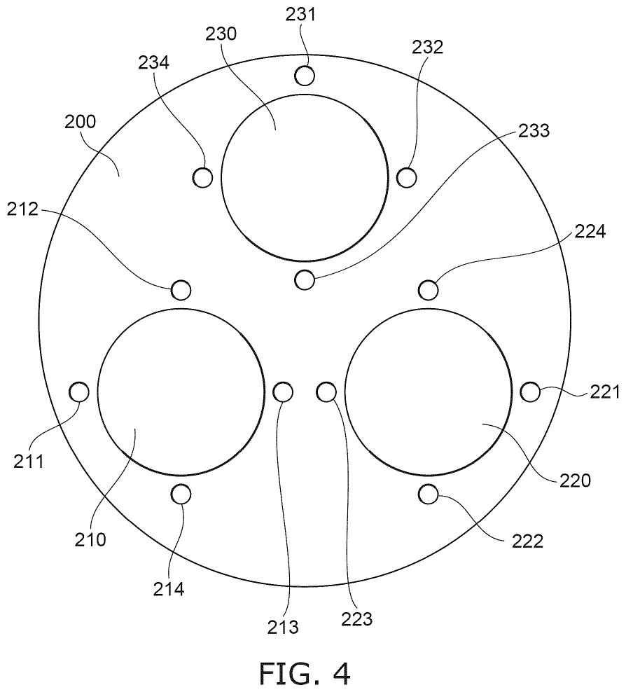

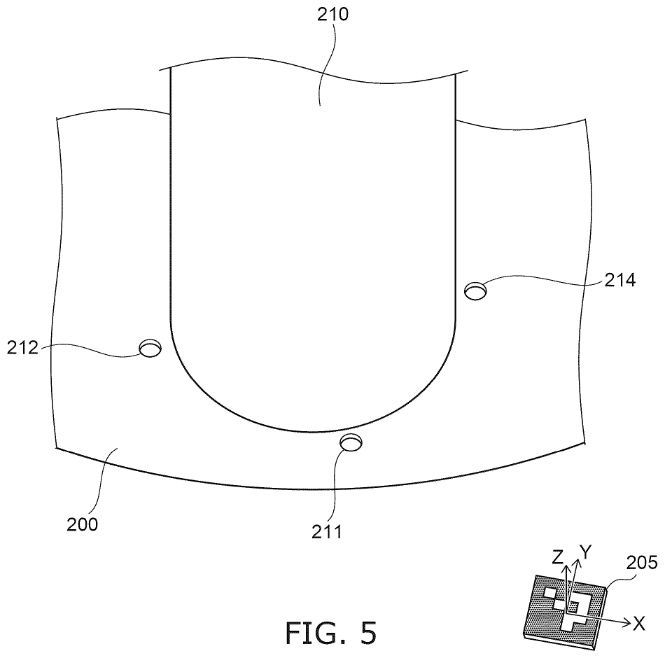

FIGS. 3 and 5 are schematic views illustrating a task. FIG. 4 is a plan view showing the article on which the task is performed.

In the example shown in FIG. 3, workers W1 and W2 perform the task on an article 200. The worker W1 wears the display device 100a and turns screws of the article 200. The worker W2 wears the display device 100b and turns screws of the article 200.

Fastening locations (screw holes) at which screws are turned are present at the upper surface of the article 200. For example, as shown in FIG. 3, a member 210, a member 220, and a member 230 that are cylindrical are located on the article 200. As shown in FIG. 4, fastening locations 211 to 214 (examples of first fastening locations) for fixing the member 210 are present around the member 210. Similarly, fastening locations 221 to 224 (examples of second fastening locations) are present around the member 220. Fastening locations 231 to 234 (examples of third fastening locations) are present around the member 230. The workers W1 and W2 sequentially turn screws at the fastening locations by using a wrench and an extension bar.

As shown in FIG. 5, a marker 205 is located proximate to the task object. The marker 205 is an AR marker. As described below, the marker 205 is provided for setting the origin of the three-dimensional coordinate system. Instead of the AR marker, a one-dimensional code (a barcode), a two-dimensional code (a QR code (registered trademark)), etc., may be used as the marker 205. Or, instead of a marker, the origin may be indicated by a hand gesture. The processing device 150 sets the three-dimensional coordinate system by using multiple points indicated by the hand gesture as a reference.

When starting the task, the display devices 100 set the three-dimensional coordinate system. Specifically, the image camera 131 and the depth camera 132 of each display device 100 image the marker 205. The processing device 150 recognizes the marker 205 based on the image that is imaged. The processing device 150 sets the three-dimensional coordinate system by using the position and orientation of the marker 205 as a reference.

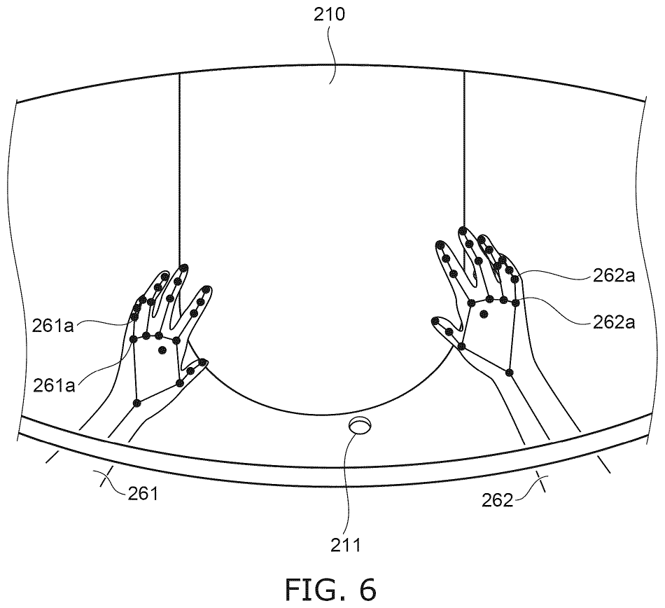

FIG. 6 is a schematic view showing an output example of the display device according to the embodiment.

During the task, the image camera 131 and the depth camera 132 image the article 200, a left hand 261 of the worker, and a right hand 262 of the worker. The processing device 150 recognizes the left and right hands 261 and 262 based on the captured image by hand tracking. The processing device 150 may cause the projection devices 121 and 122 to display the recognition result on the lenses 111 and 112. Hereinafter, the display device or the processing device using the projection device to display information on the lens also is called simply “displaying information”.

For example, as shown in FIG. 6, the processing device 150 displays the recognition result of the left hand 261 and the recognition result of the right hand 262 to overlap the hands in real space. In the illustrated example, multiple virtual objects 261a and multiple virtual objects 262a are displayed as the recognition results of the left and right hands 261 and 262. The multiple virtual objects 261a respectively indicate multiple joints of the left hand 261. The multiple virtual objects 262a respectively indicate multiple joints of the right hand 262. Virtual objects (meshes) that indicate the surface shape of the left hand 261 and the surface shape of the right hand 262 may be displayed instead of the joints.

When the left hand 261 and the right hand 262 are recognized, the processing device 150 measures the positions of the hands. Specifically, each hand includes multiple joints such as a DIP joint, a PIP joint, an MP joint, a CM joint, etc. The position of any of these joints is used as the position of the hand. The centroid position of multiple joints may be used as the position of the hand. Or, the center position of the entire hand may be used as the position of the hand.

The processing device 150 also calculates the position and direction of the display device 100. As an example, the processing device 150 uses a spatial mapping function to calculate the position and direction of the display device 100. More specifically, the depth camera 132 measures distances to objects in the surrounding area of the display device 100. Surface information of objects in the surrounding area is obtained from the measurement result (the depth image) of the depth camera 132. The surface information includes the positions and directions of the surfaces of the objects. For example, the surface of each object is represented by multiple meshes; and the position and direction of each mesh are calculated. Based on the surface information, the processing device 150 calculates the relative position and direction of the display device 100 with respect to the surfaces of the objects in the surrounding area.

When the marker 205 is recognized, the positions of the surfaces also are represented using the three-dimensional coordinate system having the marker 205 as the origin. The position and direction of the display device 100 in the three-dimensional coordinate system are calculated based on the positional relationship between the display device 100 and the surfaces of the objects. Herein, the direction of the display device 100 refers to the direction of the front of the display device 100. For example, when the worker wears the display device 100, the direction of the display device 100 is parallel to the frontward direction of the face of the worker.

The spatial mapping is repeatedly performed at a prescribed interval. The surface information of the objects in the surrounding area is obtained each time the spatial mapping is performed. The processing device 150 calculates the changes of the positions and directions of the surfaces between the result of the latest spatial mapping and the result of the directly-previous spatial mapping. In circumstances in which the objects in the surrounding area do not move, changes of the positions of the surfaces and changes of the directions of the surfaces correspond to a change of the position of the display device 100 and a change of the direction of the display device 100. The processing device 150 calculates the change amounts of the position and direction of the display device 100 based on the changes of the positions of the surfaces and the changes of the directions of the surfaces. The detection result of the sensor 140 also may be used to calculate the change amounts of the position and direction of the display device 100. The processing device 150 updates the position and direction of the display device 100 based on the obtained change amount. Instead of spatial mapping, existing positioning methods may be used to acquire the position and direction of the display device 100.

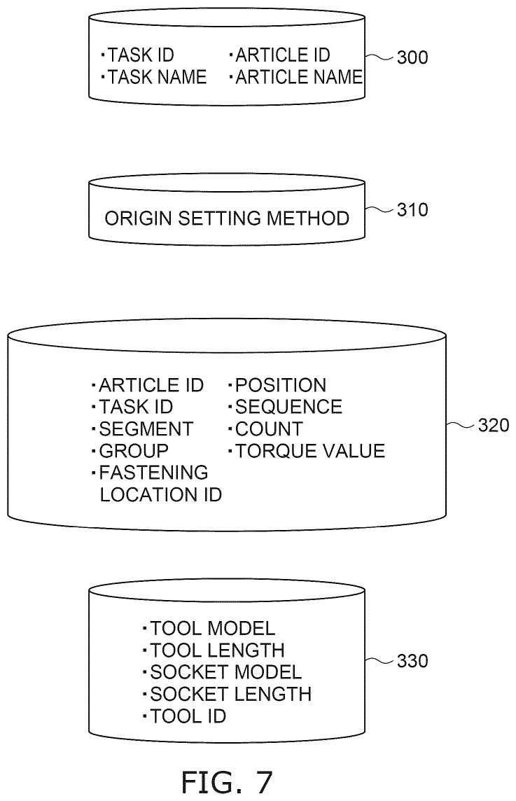

FIG. 7 is a schematic view illustrating master data that is referenced according to the embodiment of the invention.

Various data is referenced when the task is performed. For example, as shown in FIG. 7, task master data 300, origin master data 310, fastening location master data 320, and tool master data 330 are referenced.

A task ID, a task name, an article ID, and an article name are registered in the task master data 300. The task that is being performed is designated by the task ID, the task name, the ID of the article on which the task is performed, the name of the article, etc.

The setting method of the origin is registered for each task in the origin master data 310. The processing device 150 acquires the setting method of the origin for the selected task and sets the origin according to the setting method.

The identification information (ID) of the fastening locations at which the screws are turned, the positions of the fastening locations, the sequence of the task, etc., are registered for each task in the fastening location master data 320. Details of the fastening location master data 320 are described below.

The ID of the tool to be used, the model of the tool, the length of the tool, the model of the socket, the length of the socket, etc., are registered for each task in the tool master data 330. The model of the tool indicates the classification of the tool by structure, exterior shape, performance, etc. The length of the tool is the length from the rotation center to the grip when the tool is used for screw-tightening. The model of the socket indicates the classification of the socket by structure or exterior shape. The length of the socket refers to the length of the socket in the direction connecting the tool and the screw when tightening the screw. When an extension bar is used, the model, length, etc., of the extension bar also are registered in the tool master data 330.

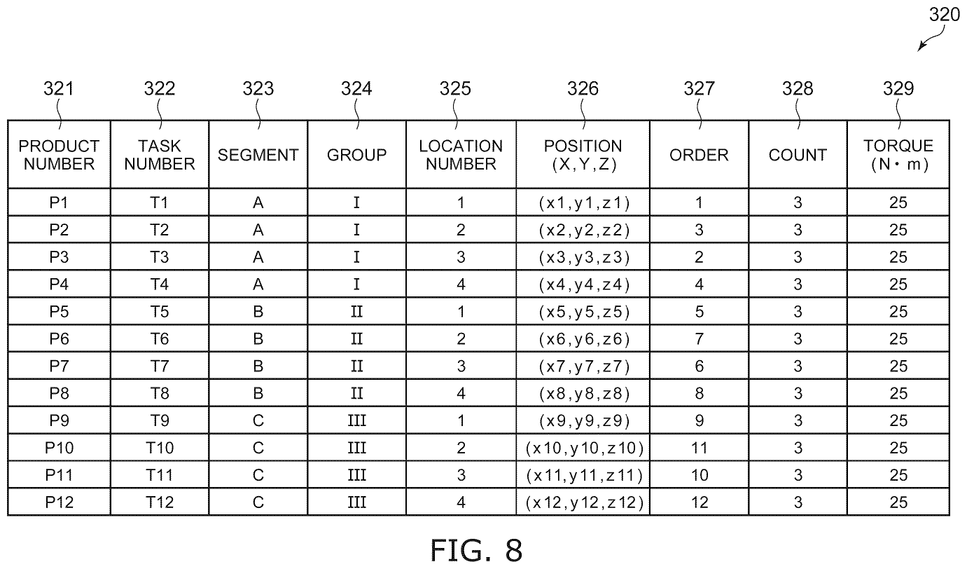

FIG. 8 is a table illustrating fastening location master data.

The fastening location master data 320 shown in FIG. 8 includes identification information 321 of the article (the product to be produced), identification information 322 of the task, a segment 323, a group 324, identification information 325 of the fastening location, a position 326, a sequence 327, a count 328, and a torque value 329.

The identification information 321 is unique identification information for each article. The identification information 322 is unique identification information for each task. The segment 323 refers to collections to which the fastening locations belong. The segment 323 is determined according to the position of each fastening location of the article, and is determined according to the relationship between the structure of the article and each fastening location. For example, multiple fastening locations that are proximate to each other on the article are grouped in one segment. Or, multiple fastening locations that correspond to one part, one unit, or one semifinished product are grouped as one segment. In the example shown in FIGS. 3 and 4, the fastening locations 211 to 214, the fastening locations 221 to 224, and the fastening locations 231 to 234 correspond respectively to the member 210, the member 220, and the member 230. Therefore, the aggregate of the fastening locations 211 to 214, the aggregate of the fastening locations 221 to 224, and the aggregate of the fastening locations 231 to 234 are treated as mutually-different segments.

The group 324 indicates the group to which each fastening location belongs. The method for assigning the fastening locations to the groups is arbitrary. For example, when data of the segment 323 exists, the multiple fastening locations that belong to a common segment are grouped as one group. When there is no data of the segment 323, the multiple fastening locations that are proximate to each other are grouped as one group.

The identification information 325 is identification information for each fastening location. The combination of the identification information 321, the segment 323, and the identification information 325 represents unique identification information for each fastening location. The position 326 indicates the position of each fastening location. The position is represented using the three-dimensional coordinate system set using the marker 205. The sequence 327 indicates the sequence of the task at each fastening location. When the segment 323 is set for each fastening location, the sequence of the task is set for each segment.

The count 328 indicates the number of times that the screw is to be tightened at each fastening location. When the number of times set in the count 328 is not less than 2, the sequence 327 indicates the sequence of the first screw-tightening. The sequence 327 may set the sequence of the screw-tightening for each time the screw-tightening is performed. The torque value 329 indicates the torque value necessary for the screw-tightening at each fastening location.

The fastening locations 211 to 214, the fastening locations 221 to 224, and the fastening locations 231 to 234 each are assigned to one of the multiple groups in the fastening location master data 320.

For example, various master data is prepared before the task and stored in a memory region of the host computer 100e. The host computer 100e may generate a part of the data included in the fastening location master data 320. For example, when data of the segment 323 exists, the host computer 100e generates the data of the group 324 by assigning the multiple fastening locations belonging to a common segment to one group. When there is no data of the segment 323 and the sequence 327, the host computer 100e assigns the multiple fastening locations that are proximate to each other to one group based on the data of the position 326.

The host computer 100e may generate the data of the group 324 based on the positions of the display devices 100a and 100b. Specifically, the host computer 100e acquires the positions of the display devices 100a and 100b via the terminal devices 100c and 100d. The host computer 100e calculates the distances between the display devices 100a and 100b and the fastening locations. The host computer 100e assigns one group to a preset number of fastening locations in order from the fastening locations proximate to the display devices 100a and 100b.

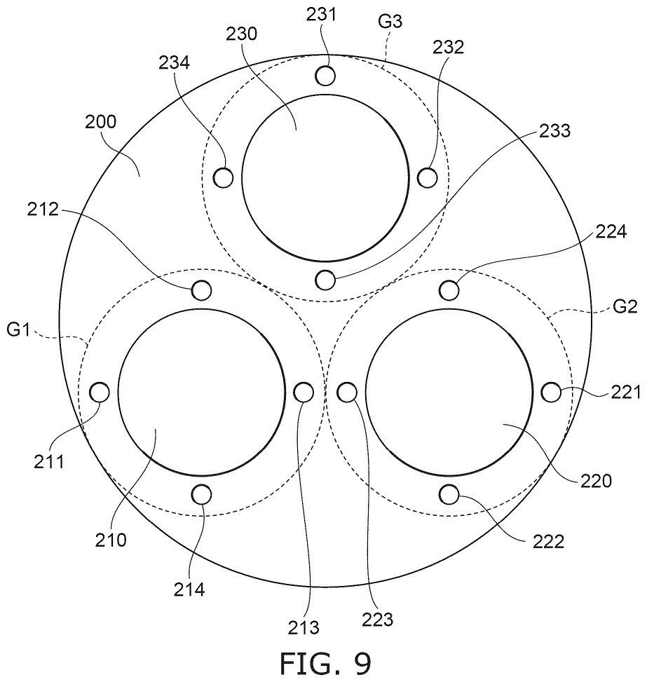

FIG. 9 is a plan view showing the article on which the task is performed.

In the illustrated example, the aggregate of the fastening locations 211 to 214, the aggregate of the fastening locations 221 to 224, and the aggregate of the fastening locations 231 to 234 are treated as mutually-different segments. Then, the sequence of the task is prespecified for each segment. Therefore, as shown in FIG. 9, the fastening locations 211 to 214, the fastening locations 221 to 224, and the fastening locations 231 to 234 are assigned respectively to a first group G1, a second group G2, and a third group G3.

When the task is performed, the host computer 100e acquires the fastening location master data 320. The host computer 100e assigns the worker (the display device) to perform the task for the fastening locations by group. For example, the host computer 100e acquires the positions of the display devices 100a and 100b via the terminal devices 100c and 100d. The host computer 100e calculates the distances to the fastening locations belonging to each group from the display device 100a and from the display device 100b. The host computer 100e assigns, to the display device 100a, the group including the fastening locations most proximate to the display device 100a. The host computer 100e assigns, to the display device 100b, the group including the fastening locations most proximate to the display device 100b.

The host computer 100e transmits the fastening location master data 320 and the assignment of the workers by group to the terminal devices 100c and 100d. Based on the received data, the terminal device 100c determines the fastening location on which the wearer of the display device 100a should now perform the task. The display device 100a transmits the determination result to the display device 100a. Based on the received data, the terminal device 100d determines the fastening location on which the wearer of the display device 100b should now perform the task. The terminal device 100d transmits the determination result to the display device 100b.

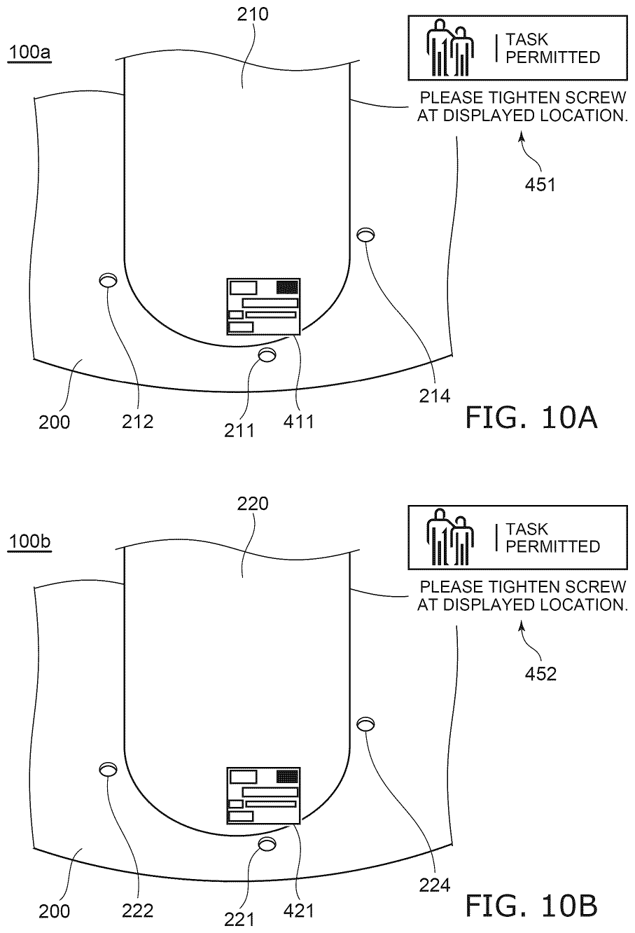

FIGS. 10A, 10B, 11A, 11B, 12A, 12B, 13A, and 13B are schematic views showing output examples of the display device according to the embodiment.

When receiving data indicating the fastening location at which the task is to be performed, the display device 100a and the display device 100b display virtual objects at the fastening locations.

As an example, the first group G1 is assigned to the display device 100a (the worker W1); and the second group G2 is assigned to the display device 100b (the worker W2). The wearer of the display device 100a is determined to perform the task at the fastening location 211. As shown in FIG. 10A, the display device 100a displays a virtual object 411 (an example of a first virtual object) at the fastening location 211. The wearer of the display device 100b is determined to perform the task at the fastening location 221. As shown in FIG. 10B, the display device 100b displays a virtual object 421 (an example of a second virtual object) at the fastening location 221.

The virtual object 411 is displayed not to overlap the fastening location 211, and is positioned proximate to the fastening location 211. For example, the distance between the fastening location 211 and the virtual object 411 is less than the distances between the virtual object 411 and the other fastening locations. Similarly, the virtual object 421 is displayed not to overlap the fastening location 221, and is positioned proximate to the fastening location 221. The distance between the fastening location 221 and the virtual object 421 is less than the distances between the virtual object 421 and the other fastening locations.

The worker W1 performs the task at the fastening location 211 at which the virtual object 411 is displayed according to the display of the virtual object 411. The worker W2 performs the task at the fastening location 221 at which the virtual object 421 is displayed according to the display of the virtual object 421. By displaying the virtual objects 411 and 421, the worker can easily ascertain the fastening location at which the task is to be performed.

As shown in FIGS. 10A and 10B, the display device 100a and the display device 100b may respectively display messages 451 and 452 in addition to the virtual objects. The message 451 is an instruction of the task to the worker W1. The message 452 is an instruction of the task to the worker W2. For example, when it is necessary to adjust the timing of the task of the worker W1 and the timing of the task of the worker W2, the workers W1 and W2 can use the display of the messages 451 and 452 to easily ascertain whether or not the task may be performed. The instruction of the task may be output as an image as illustrated, or may be output as a voice.

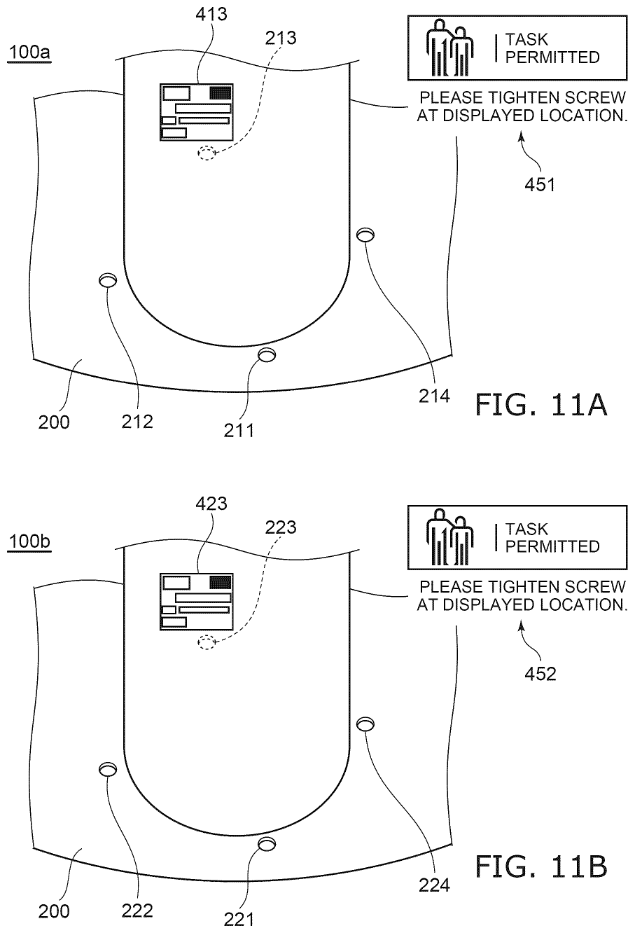

When the task at the fastening location 211 is finished, the terminal device 100c refers to the sequence 327 of the fastening location master data 320 and determines the next fastening location at which the task is to be performed. The terminal device 100c transmits the determination result to the display device 100a. As shown in FIG. 11A, the display device 100a displays a virtual object 413 (another first virtual object) at a fastening location 213 (another first fastening location). Similarly, when the task at the fastening location 221 is finished, the terminal device 100d determines the next fastening location at which the task is to be performed. The terminal device 100d transmits the determination result to the display device 100b. As shown in FIG. 11B, the display device 100b displays a virtual object 423 (another second virtual object) at a fastening location 223 (another second fastening location).

During the task, the terminal device 100c and the terminal device 100d generate a task record of which fastening locations had the screws turned. Based on the record of the task, the end of the task at the fastening locations of the first group G1 and the end of the task at the fastening locations of the second group G2 can be determined. When the task assigned to the worker W1 or the task assigned to the worker W2 is finished, the host computer 100e assigns the task at the fastening locations of the third group G3 to the worker that finished the task more quickly.

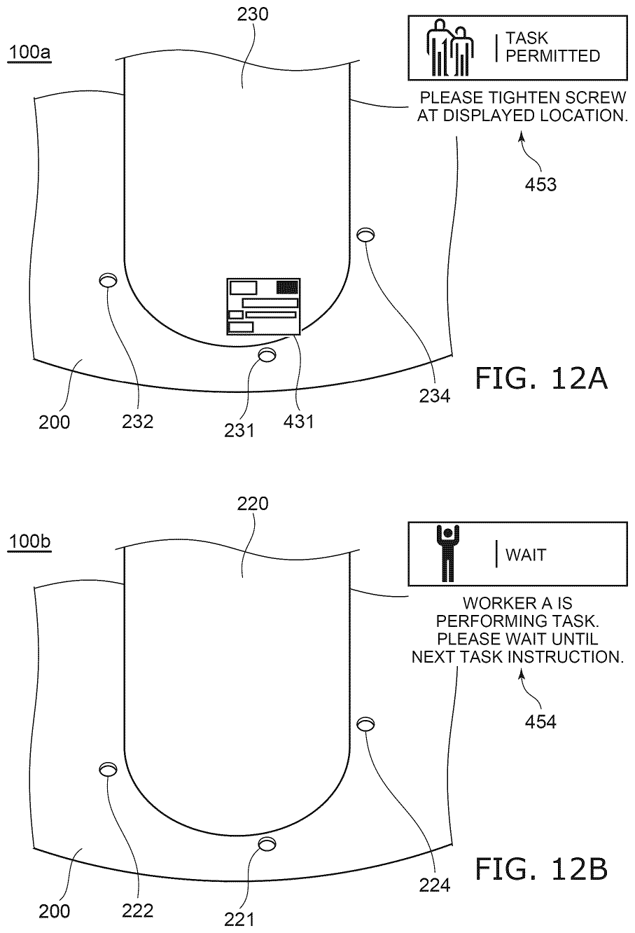

As an example, the worker W1 finishes the task earlier than the worker W2. In such a case, the host computer 100e assigns the task at the fastening locations of the third group G3 to the display device 100a. As shown in FIG. 12A, the display device 100a displays a virtual object 431 (an example of a third virtual object) to the fastening location 231 (a third fastening location) of the third group G3.

As shown in FIG. 12A, the display device 100a may display a message 453. The message 453 is an instruction of the task to the worker W1. The worker W2 waits from when the worker W2 finishes the task until the worker W1 finishes the task. At this time, as shown in FIG. 12B, the display device 100b may display a message 454. The message 454 is a wait instruction to the worker W2.

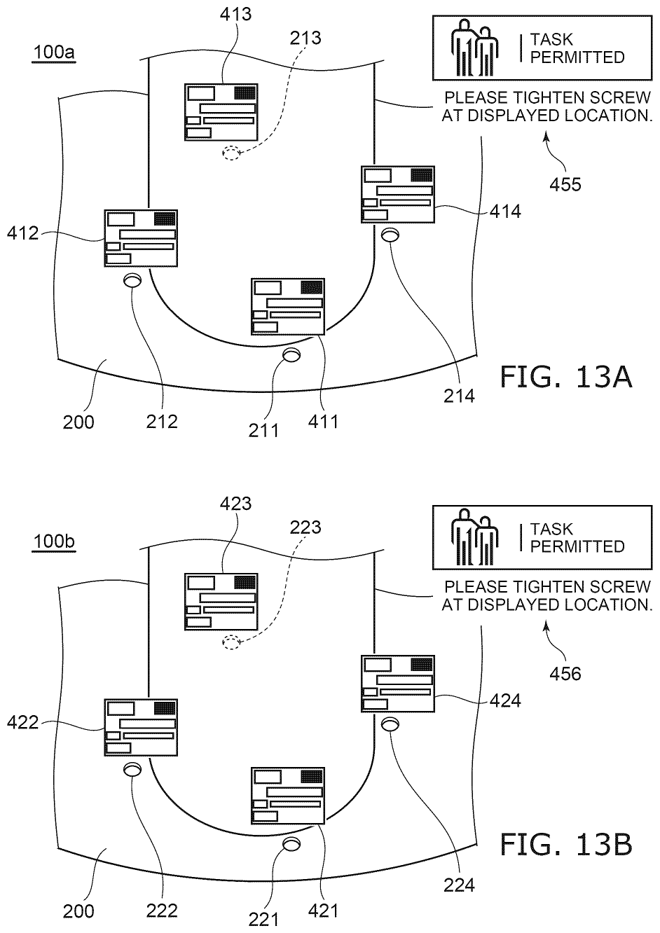

When the worker W1 finishes the task, the first screw-tightening is completed for all of the fastening locations. Subsequently, a second screw-tightening is performed for the fastening locations. When the sequence of the second screw-tightening is not specified, for example, the display device 100a and the display device 100b display virtual objects at all of the fastening locations as shown in FIGS. 13A and 13B. In the illustrated example, the virtual objects 411 to 414 are displayed respectively at the fastening locations 211 to 214. The virtual objects 421 to 424 are displayed respectively at the fastening locations 221 to 224. The virtual objects 431 to 434 are displayed respectively at the fastening locations 231 to 234. As illustrated, a message 455 and a message 456 also may be displayed.

The worker W1 and the worker W2 sequentially perform the task at the fastening locations at which the virtual objects are displayed. The display of the virtual object may disappear for the fastening locations at which the task has been performed. Or, the display of the virtual object may be changed. As a result, the workers can easily ascertain which of the fastening locations have been subjected to the second screw-tightening.

Or, similarly to the examples of FIGS. 10A to 11B, one virtual object may be sequentially displayed at each fastening location. For example, the display device 100a calculates the distances between the display device 100a and the fastening locations. The display device 100a displays a virtual object at the most proximate fastening location on which the second task has not been performed. Similarly, the display device 100b calculates the distances between the display device 100b and the fastening locations. The display device 100b displays a virtual object at the most proximate fastening location on which the second task has not been performed.

When the sequence of the second screw-tightening is specified, similarly to the first screw-tightening, the host computer 100e assigns the groups to the display devices 100a and 100b. The terminal device 100c and the terminal device 100d determine the fastening location at which the task is to be performed. The display device 100a and the display device 100b display the virtual objects according to the specified sequence.

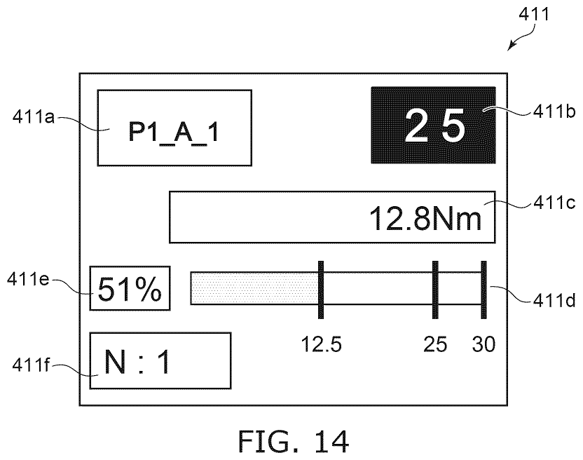

FIG. 14 is a schematic view showing a specific example of the virtual object.

The virtual object may include information of the task. For example, as shown in FIG. 13A, the virtual object 411 includes task information such as an identification information 411a, a specified torque value 411b, a detected value 411c, a meter 411d, a percentage 411e, and a count 411f. The identification information 411a is unique identification information assigned to the fastening location 211, and is a character string. The specified torque value 411b is the torque value necessary for the screw-tightening at the fastening location 211, and is prespecified.

In the task, a tool that can detect the torque value may be used. In such a case, the detected value 411c is the torque value detected by the tool. The meter 411d indicates the specified torque value and the detected torque value. The percentage 411e indicates the ratio of the detected value to the specified torque value. According to the task, it may be desirable to tighten the screw multiple times at one fastening location. In such a case, the count 411f indicates the number of times that the screw is tightened at the fastening location 211.

Similarly to the example shown in FIG. 14, virtual objects 412 to 414, the virtual objects 421 to 424, and the virtual objects 431 to 434 also include information of the task at the fastening locations. The worker performs the task while confirming the content displayed in the virtual object. By displaying the information necessary for the task in the virtual object, the efficiency of the task can be increased.

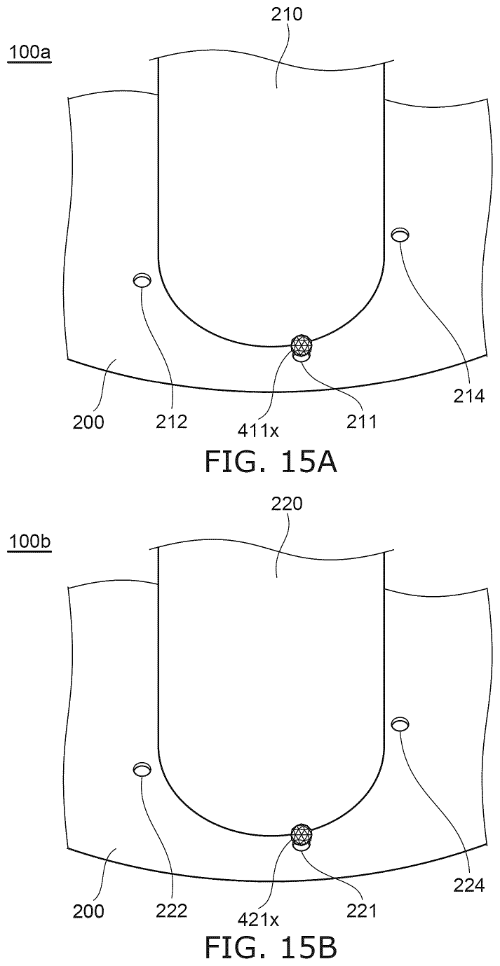

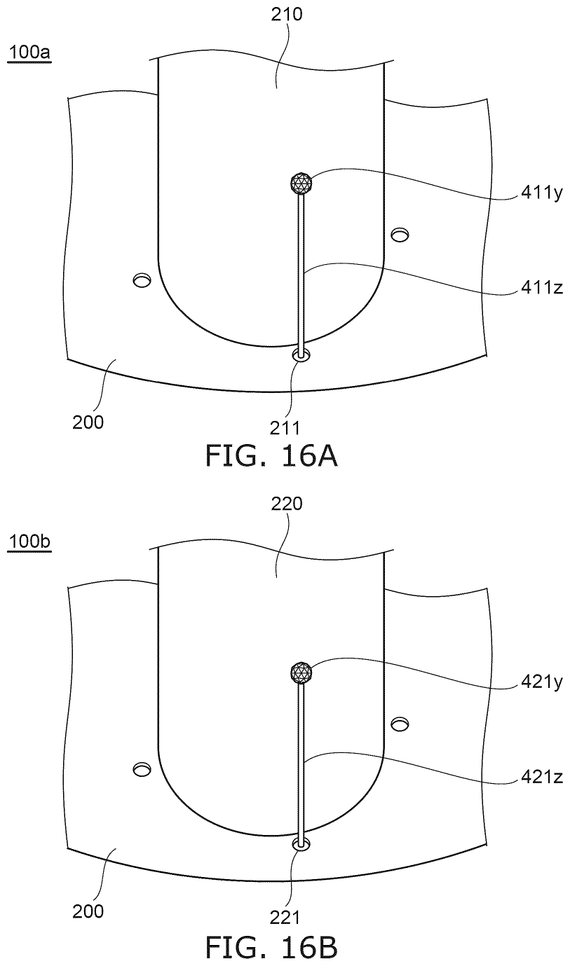

FIGS. 15A, 15B, 16A, and 16B are schematic views showing output examples of the display device according to the embodiment.

The display device 100 may display virtual objects of a different form from the virtual objects shown in FIGS. 10A to 13B. For example, as shown in FIG. 15A, the display device 100a may display a spherical virtual object 411x at the fastening location 211. The virtual object 411x is displayed to overlap the fastening location 211. Similarly, as shown in FIG. 15B, the display device 100b may display a spherical virtual object 421x at the fastening location 221. The virtual object 421x is displayed to overlap the fastening location 221. The virtual object 411x is another example of the first virtual object. The virtual object 421x is another example of the second virtual object.

The virtual objects 411x and 421x are displayed at the fastening locations at which the task is to be performed. By using the display of the virtual objects 411x and 421x, the workers W1 and W2 can easily ascertain the fastening locations on which the task should now perform.

Or, as shown in FIG. 16A, the display device 100a may display virtual objects 411y and 411z at the fastening location 211. The display device 100b may display virtual objects 421y and 421z at the fastening location 221. The virtual object 411y is separated from the fastening location 211 in the direction of the screw hole of the fastening location 211. The virtual object 411z is positioned between the fastening location 211 and the virtual object 411y. The virtual object 421y is separated from the fastening location 221 in the direction of the screw hole of the fastening location 221. The virtual object 421z is positioned between the fastening location 221 and the virtual object 421y. The virtual objects 411y and 411z are other examples of the first virtual object. The virtual objects 421y and 421z are other examples of the second virtual object.

The virtual objects 411y, 411z, 421y, and 421z are favorable when a wrench and an extension bar are used. The virtual object 411y shows the position at which the hand is to be placed when turning the screw at the fastening location 211. The virtual object 411z shows the position at which the extension bar is to be placed when turning the screw at the fastening location 211. For example, the distance between the fastening location 221 and the virtual object 411y corresponds to the length of the extension bar.

The worker W1 disposes the extension bar so that the extension bar approaches or contacts the virtual object 411z. The worker W1 grips the head of the wrench so that the hand contacts the virtual object 411y. By displaying the virtual objects 411y and 411z, the worker W1 can easily ascertain the positions at which the tool and the hand are to be placed when turning the screw at the fastening location 211. Similarly, by displaying the virtual objects 421y and 421z, the worker W2 can easily ascertain the positions at which the tool and the hand are to be placed when turning the screw at the fastening location 221. The work efficiency can be increased thereby.

In the illustrated example, the virtual objects 411x, 411y, 421x, and 421y are spherical. The virtual objects 411z and 421z are rod-shaped. The shapes of the virtual objects are not limited to the examples as long as the worker can visually recognize the virtual objects. For example, the virtual objects 411x, 411y, 421x, and 421y may be cubic. The virtual objects 411z and 421z may be wire-shaped.

After the virtual object is displayed, the processing device 150 may determine whether or not a prescribed object contacts the virtual object. For example, the processing device 150 of the display device 100a determines whether or not the hand of the wearer contacts the virtual object 411x or 411y. Specifically, the processing device 150 calculates the distance between the position of the hand and the position of the virtual object. When the distance is less than a preset threshold, the processing device 150 determines that the hand contacts the virtual object.

As an example in FIGS. 15A to 16B, the diameter of the spherical virtual objects 411x, 411y, 421x, and 421y corresponds to the threshold. The sphere indicates the range in which the hand is determined to contact the virtual object.

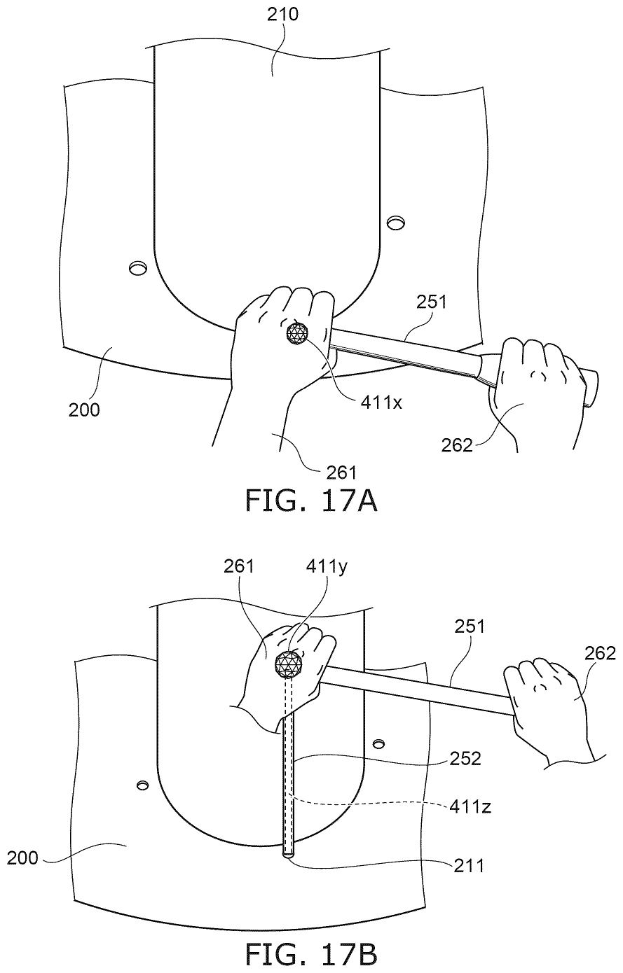

FIGS. 17A and 17B are schematic views illustrating a task.

When a wrench 251 is used as shown in FIG. 17A, the hand contacts the virtual object 411x. When the wrench 251 and an extension bar 252 are used as shown in FIG. 17B, the hand contacts the virtual object 411y. In such cases, the processing device 150 determines the contact between the hand and the virtual object.

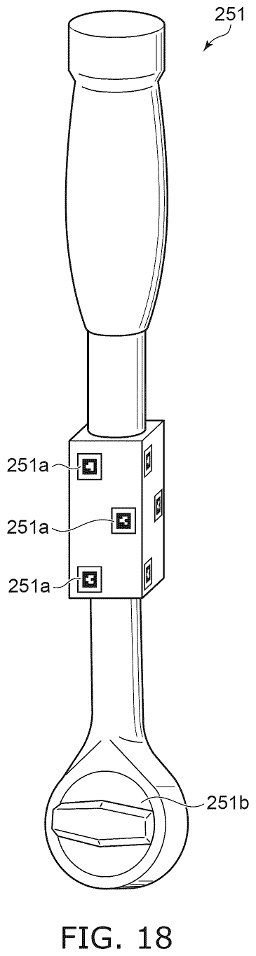

FIG. 18 is a schematic view showing an example of a tool.

The processing device 150 may determine whether or not the tool contacts a virtual object. For example, as shown in FIG. 18, multiple markers 251a are mounted to the wrench 251. The processing device 150 recognizes the multiple markers 251a based on an image that is imaged by the image camera 131. The processing device 150 measures the positions of the markers 251a. The positional relationships between a head 251b of the wrench 251 and the multiple markers 251a are preregistered. The processing device 150 calculates the position of the head 251b based on the recognized positions of at least three markers 251a and the preregistered positional relationships. The processing device 150 calculates the distance between the position of the head 251b and the position of the virtual object. When the distance is less than the preset threshold, the processing device 150 determines that the wrench 251 contacts the virtual object.

When a prescribed object contacts a virtual object, it can be estimated that a screw is being turned at the fastening location corresponding to the virtual object. In the example shown in FIG. 17A, based on the hand or the tool contacting the virtual object 411x, it is estimated that the screw is being turned at the fastening location 211 corresponding to the virtual object 411x. In the example shown in FIG. 17B, based on the hand or the tool contacting the virtual object 411y, it is estimated that the screw is being turned at the fastening location 211 corresponding to the virtual object 411y.

Other than the contact between the real object and the virtual object, the fastening location at which the task is being performed may be estimated using the movement of the hand. The hand that turns the tool moves in an arc-like shape while the tool is used to turn the screw. At this time, the position of the center of the rotation substantially does not change. For example, the position of the head of the wrench substantially does not change while the screw is being turned with the wrench. It can be estimated that the screw is being turned when the change of the position of the rotation center is small.

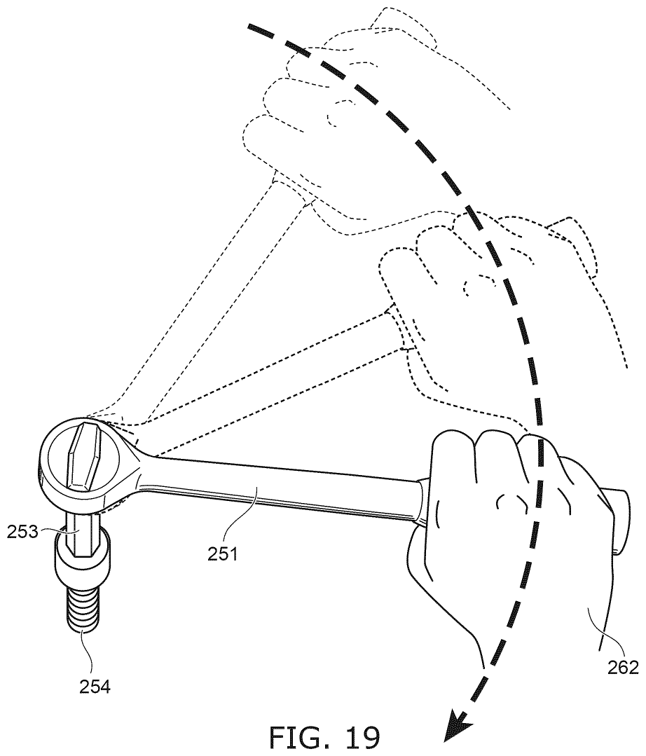

FIG. 19 is a schematic view showing a task.

For example, as shown in FIG. 19, the worker uses the wrench 251 to tighten a screw at a fastening location. Here, an example is described in which the extension bar 252 is not used. The worker places a screw 254 in a screw hole at a fastening location, which is not illustrated. The worker holds the grip of the wrench 251 with the right hand and causes the tip (the head) of the wrench 251 to which a socket is mounted to engage the screw 254. The worker turns the screw 254 by rotating the wrench 251.

The processing device 150 repeatedly measures the position of the hand while the worker turns the wrench 251. At this time, the hand is positioned on a circumference centered on a part of the wrench 251. The hand is moved to trace a circular arc. The processing device 150 utilizes this movement to estimate the center position of the rotation of the tool. The processing device 150 estimates the fastening location at which the screw is being turned, the performing of the task at the fastening location, etc., based on the center position of the rotation. For example, the following first or second calculation method is used to calculate the center position.

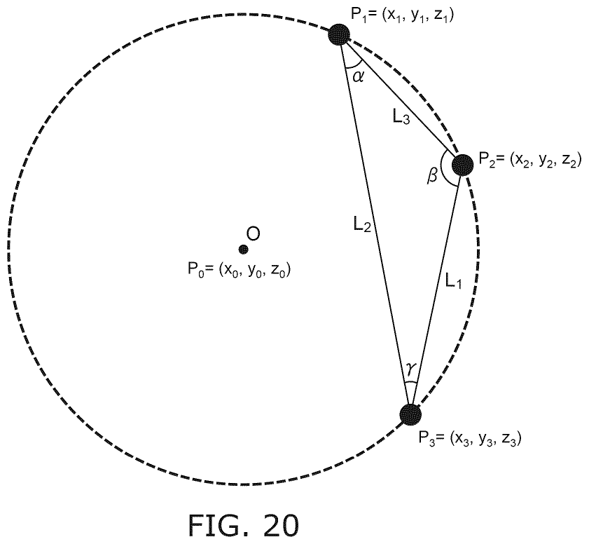

FIGS. 20, 21A, 21B, 22, and 23 are schematic views for describing calculation methods according to the first embodiment of the invention.

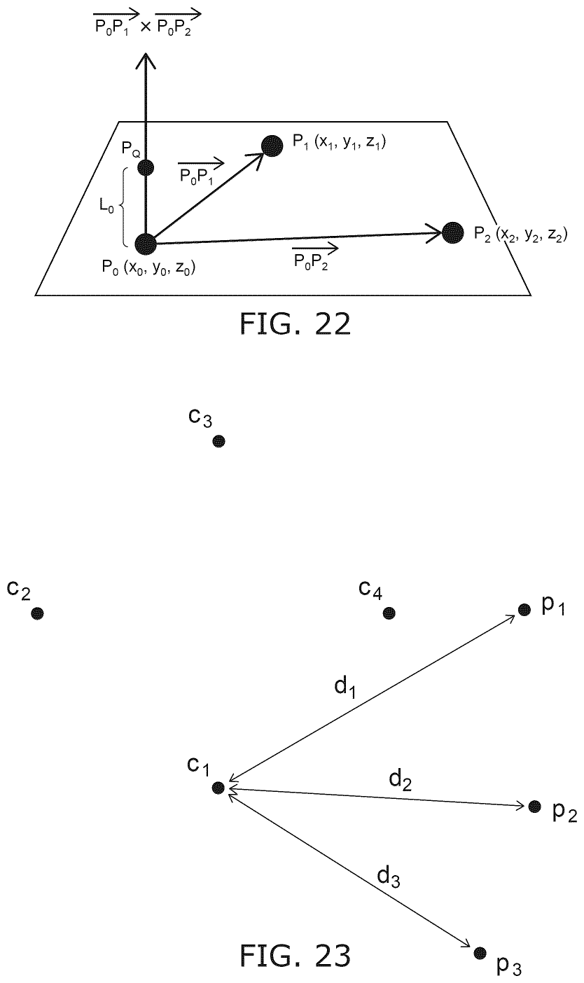

In the first calculation method, the processing device 150 extracts three mutually-different positions from the multiple positions that are measured. The processing device 150 calculates a circumcenter O of the three positions. Here, as shown in FIG. 22, the three positions are taken as P₁(x₁, y₁, z₁), P₂(x₂, y₂, z₂), and P₃ (x₃, y₃, z₃). The position of the circumcenter O is taken as P₀ (x₀, y₀, z₀). The length of the side opposite to the position P₁ of a triangle obtained by connecting the positions P₁ to P₃ to each other is taken as L₁. The length of the side opposite to the position P₂ is taken as L₂. The length of the side opposite to the position P₃ is taken as L₃. The angle at the position P₁ is taken as α. The angle at the position P₂ is taken as β. The angle at the position P₃ is taken as y. In such a case, the position of the circumcenter O is represented by the following Formula (1). In Formula (1), the symbols marked with arrows represent position vectors. Formula (1) can be rewritten as Formula (2). Formula (2) can be broken down into Formulas (3) to (5).

$$\vec{{P}_{0}} = \frac{{L}_{1}^{2} ( {L}_{2}^{2} + {L}_{3}^{2} - {L}_{1}^{2} ) \vec{P 1} + {L}_{2}^{2} ( {L}_{3}^{2} + {L}_{1}^{2} - {L}_{2}^{2} ) \vec{P 2} + {L}_{3}^{2} ( {L}_{1}^{2} + {L}_{2}^{2} - {L}_{3}^{2} ) \vec{P 3}}{{L}_{1}^{2} ( {L}_{2}^{2} + {L}_{3}^{2} - {L}_{1}^{2} ) + {L}_{2}^{2} ( {L}_{3}^{2} + {L}_{1}^{2} - {L}_{2}^{2} ) + {L}_{3}^{2} ( {L}_{1}^{2} + {L}_{2}^{2} - {L}_{3}^{2} )} \qquad [ Formula 1 ]$$

$$( {x}_{0} , {y}_{0} , {z}_{0} ) = \frac{{L}_{1}^{2} ( {L}_{2}^{2} + {L}_{3}^{2} - {L}_{1}^{2} ) ( {x}_{1} , {y}_{1} , {z}_{1} ) + {L}_{2}^{2} ( {L}_{3}^{2} + {L}_{1}^{2} - {L}_{2}^{2} ) ( {x}_{2} , {y}_{2} , {z}_{2} ) + {L}_{3}^{2} ( {L}_{1}^{2} + {L}_{2}^{2} - {L}_{3}^{2} ) ( {x}_{3} , {y}_{3} , {z}_{3} )}{{L}_{1}^{2} ( {L}_{2}^{2} + {L}_{3}^{2} - {L}_{1}^{2} ) + {L}_{2}^{2} ( {L}_{3}^{2} + {L}_{1}^{2} - {L}_{2}^{2} ) + {L}_{3}^{2} ( {L}_{1}^{2} + {L}_{2}^{2} - {L}_{3}^{2} )} \qquad [ Formula 2 ]$$

$${x}_{0} = \frac{{L}_{1}^{2} ( {L}_{2}^{2} + {L}_{3}^{2} - {L}_{1}^{2} ) {x}_{1} + {L}_{2}^{2} ( {L}_{3}^{2} + {L}_{1}^{2} - {L}_{2}^{2} ) {x}_{2} + {L}_{3}^{2} ( {L}_{1}^{2} + {L}_{2}^{2} - {L}_{3}^{2} ) {x}_{3}}{{L}_{1}^{2} ( {L}_{2}^{2} + {L}_{3}^{2} - {L}_{1}^{2} ) + {L}_{2}^{2} ( {L}_{3}^{2} + {L}_{1}^{2} - {L}_{2}^{2} ) + {L}_{3}^{2} ( {L}_{1}^{2} + {L}_{2}^{2} - {L}_{3}^{2} )} \qquad [ Formula 3 ]$$

$${y}_{0} = \frac{{L}_{1}^{2} ( {L}_{2}^{2} + {L}_{3}^{2} - {L}_{1}^{2} ) {y}_{1} + {L}_{2}^{2} ( {L}_{3}^{2} + {L}_{1}^{2} - {L}_{2}^{2} ) {y}_{2} + {L}_{3}^{2} ( {L}_{1}^{2} + {L}_{2}^{2} - {L}_{3}^{2} ) {y}_{3}}{{L}_{1}^{2} ( {L}_{2}^{2} + {L}_{3}^{2} - {L}_{1}^{2} ) + {L}_{2}^{2} ( {L}_{3}^{2} + {L}_{1}^{2} - {L}_{2}^{2} ) + {L}_{3}^{2} ( {L}_{1}^{2} + {L}_{2}^{2} - {L}_{3}^{2} )} \qquad [ Formula 4 ]$$

$${z}_{0} = \frac{{L}_{1}^{2} ( {L}_{2}^{2} + {L}_{3}^{2} - {L}_{1}^{2} ) {z}_{1} + {L}_{2}^{2} ( {L}_{3}^{2} + {L}_{1}^{2} - {L}_{2}^{2} ) {z}_{2} + {L}_{3}^{2} ( {L}_{1}^{2} + {L}_{2}^{2} - {L}_{3}^{2} ) {z}_{3}}{{L}_{1}^{2} ( {L}_{2}^{2} + {L}_{3}^{2} - {L}_{1}^{2} ) + {L}_{2}^{2} ( {L}_{3}^{2} + {L}_{1}^{2} - {L}_{2}^{2} ) + {L}_{3}^{2} ( {L}_{1}^{2} + {L}_{2}^{2} - {L}_{3}^{2} )} \qquad [ Formula 5 ]$$

x₀, y₀, and z₀ are calculated respectively from Formulas (3) to (5). The processing device 150 calculates the position P₀ (x₀, y₀, z₀) of the circumcenter O as the center position of the rotation of the wrench 251.

The center position of the rotation of the wrench 251 can be considered to be the position at which the screw 254 is being turned by the wrench 251. Then, it can be estimated that the screw is being tightened at the fastening location most proximate to the center position. For example, the processing device 150 extracts a combination of three positions from the multiple positions of the hand measured in a prescribed duration, and calculates the center position. The processing device 150 repeats the extraction of the combination of the positions and the calculation of the center position. The processing device 150 calculates the distances between the fastening location and the center positions calculated for the duration, and estimates that the screw is being turned at the fastening location when one of the distances is less than a threshold.

When a digital tool that can detect the torque value is used, the detection result of the tool may be used to estimate the task. For example, when the torque value is detected by the tool and the distances between the fastening location and the center positions for a prescribed duration all are less than the threshold, the processing device 150 estimates that the screw is being turned at the fastening location.

To more accurately estimate the position of the screw in the first calculation method described above, the length of the tool interposed between the wrench 251 and the screw 254 may be used in the calculation. In the example shown in FIG. 19, a socket 253 engages the wrench 251. In other words, the center position of the rotation of the wrench 251 and the position of the screw 254 are separated by the length of the socket 253. When the length of the socket 253 is preregistered, the processing device 150 can use the center position and the length of the socket 253 to more accurately estimate the position of the screw 254.

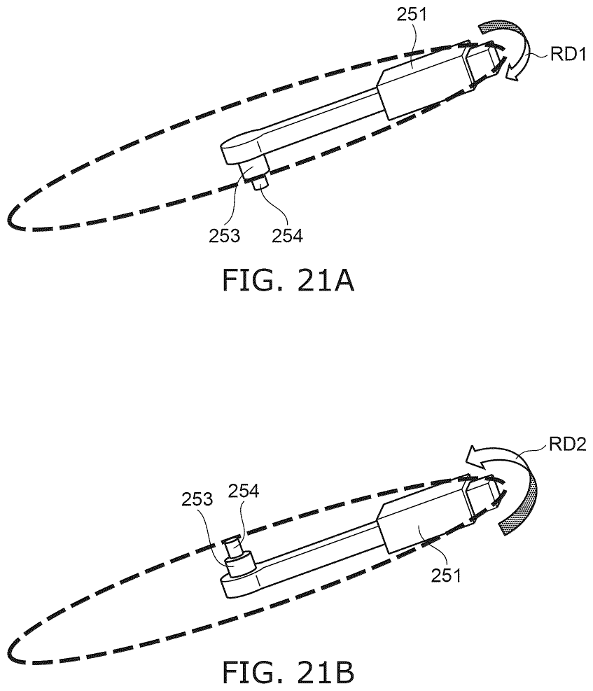

When using the length of the socket 253 to estimate the position of the screw 254, it is necessary to determine the side at which the screw 254 is positioned with respect to the plane in which the wrench 251 is rotating. In the example shown in FIG. 21A, the wrench 251 rotates in a rotation direction RD1. The screw 254 and the socket 253 are positioned at the lower side. In the example shown in FIG. 21B, the wrench 251 rotates in a rotation direction RD2. The rotation direction RD2 is the opposite of the rotation direction RD1. The screw 254 and the socket 253 are positioned at the upper side of a plane parallel to the rotation direction RD2.

To determine the side at which the screw 254 is positioned, the processing device 150 uses the center position, two positions of the hand, time-series information of the two positions, and tighten/loosen information of the screw. For example, as shown in FIG. 22, the two positions are taken as P₁ (x₁, y₁, z₁) and P₂ (x₂, y₂, z₂). The center position is taken as P₀ (x₀, y₀, z₀). The time at which the hand is at the position P₁ and the time at which the hand is at the position P₂ are known. In other words, the processing device 150 stores time-series information of the positions P₁ and P₂. In the example, the time at which the hand was positioned at the position P₁ is before the time at which the hand was positioned at the position P₂.

The tighten/loosen information indicates whether the screw is being tightened or loosened. When the wrench 251 is a digital tool, the wrench 251 generates the tighten/loosen information by determining whether the screw is being tightened or loosened based on the detected torque value. The processing device 150 may generate the tighten/loosen information by determining whether the screw is being tightened or loosened based on the time-series data of the torque value received from the wrench 251.

A plane that passes through the positions P₀ to P₂ is represented by the following Formula (6). In Formula (6), k, l, m, and n are constants.

$$kx + ly + mz + n = 0 \qquad [ Formula 6 ]$$

The following Formulas (7) to (9) are obtained by substituting the positions of P₀ to P₂ in Formula (6). The constants k, l, m, and n are calculated from Formulas (7) to (9).

$${kx}_{0} + {ly}_{0} + {mz}_{0} + n = 0 \qquad [ Formula 7 ]$$

$${kx}_{1} + {ly}_{1} + {mz}_{1} + n = 0 \qquad [ Formula 8 ]$$

$${kx}_{2} + {ly}_{2} + {mz}_{2} + n = 0 \qquad [ Formula 9 ]$$

Here, the processing device 150 calculates a vector from the center position P₀ to the position P₁ at the previous time. Also, the processing device 150 calculates a vector from the center position P₀ to the position P₂ at the subsequent time. The screw 254 is at a position P_{Q} that is separated from the center position P₀ by a length L₀ of the socket 253 on the normal vector P₀P₁×P₀P₂. When the screw is being tightened and the time of the position P₁ is before the time of the position P₂, the processing device 150 calculates the normal vector P₀P₁×P₀P₂ of the vector P₀P₁ and the vector P₀P₂.

The length from the position P₀ to the position P₀ at which the wrench and the socket act on the screw is represented by the following Formula (10). In the following formulas, the symbols marked with arrows indicate that the value of the symbol is a vector.

$$\vec{\vert {P}_{0} {P}_{Q}} \vert = √ \{ {( k - {x}_{0} )}^{2} + {( l - {y}_{0} )}^{2} + {( m - {z}_{0} )}^{2} \} = {L}_{0} \qquad [ Formula 10 ]$$

On the other hand, the vector from the position P₀ to the position P_{Q} also may be represented by the following Formula (11). In Formula (11), t is a constant.

$$\vec{\vert {P}_{0} {P}_{Q}} \vert = ( k - {x}_{0} , l - {y}_{0} , m - {z}_{0} ) = t ( k , 1 , m ) \qquad [ Formula 11 ]$$

The following Formula (12) is obtained by substituting Formula (11) in Formula (10). The length L₀ in Formula (12) is preregistered. t is calculated by solving Formula (12).

$$√ \{ ( {\{ ( {y}_{1} - {y}_{0} ) ( {z}_{2} - {z}_{0} ) - ( {y}_{2} - {y}_{0} ) ( {z}_{2} - {z}_{0} ) \}}^{2} * {t}^{2} + \{ ( {z}_{1} - {z}_{0} ) ( {x}_{2} - {x}_{0} ) - ( {z}_{2} - {z}_{0} ) ( {x}_{1} - {x}_{0} ) \} * {t}^{2} + \{ ( {x}_{1} - {x}_{0} ) ( {y}_{2} - {y}_{0} ) - ( {x}_{2} - {x}_{0} ) ( {y}_{1} - {y}_{0} ) \} * {t}^{2} \} = {L}_{0} \qquad [ Formula 12 ]$$

When t is calculated, the position P₀ is calculated using the position P₀ and the constants k, l, m, n, and t. In other words, the position of the screw is obtained.

For example, the processing device 150 extracts a combination of three positions from the multiple positions of the screw 254 calculated for a prescribed duration, and calculates the center position. The processing device 150 repeats the extraction of the combination of the positions and the calculation of the center position. The processing device 150 estimates that the screw is being turned at the fastening location when one of the distances between the fastening location and the positions of the screw 254 in the duration is less than a threshold.

As shown in FIG. 17B, there are cases where the screw is fastened via the extension bar 252. In such a case as well, similarly to the method described above, the position of the screw 254 can be estimated using the length of the extension bar 252. In other words, the screw 254 is at a position separated from the center position P₀ by the sum of the length of the extension bar 252 and the length of the socket 253 on the normal vector P₀P₁×P₀P₂. The position P_{Q} of the screw 254 is estimated using the center position P₀, the length of the extension bar 252, and the length of the socket 253. The position of the screw 254 can be estimated with higher accuracy by considering the length of another tool interposed between the screw 254 and the wrench 251.

In the second calculation method, the center position of the rotation is preregistered for each fastening location. For example, as shown in FIG. 23, center positions c₁ to c₄ are preregistered for the fastening locations 211 to 214. Three positions p1 to p3 of the hand are calculated based on images of the hand turning the screw. The processing device 150 calculates distances d1 to d3 respectively between the center position c₁ and the positions p1 to p3. Similarly, the processing device 150 calculates the distances respectively between center positions c₂ to c₄ and the positions p1 to p3. The processing device 150 calculates the fluctuation of the distances respectively between each center position and the positions p1 to p3. When one of the fluctuations is less than a threshold, the processing device 150 estimates that the tool is rotating at that center position. The processing device 150 estimates that the screw is being turned at the fastening location associated with the estimated center position.

Examples of the fluctuation include an average value of multiple distances, a sum of differences between the distances, the variance of the multiple distances, the standard deviation of the multiple distances, etc. In the example shown in FIG. 23, the positions p1 to p3 of the hand are substantially equidistant from the center position c₁. It is therefore estimated that the screw is being turned at the fastening location 211 associated with the center position c₁.

When a digital tool is used, the detection result of the tool may be used to estimate the task. For example, when the center position is estimated and the torque value is detected by the tool, the processing device 150 estimates that the screw is being turned at the fastening location associated with the center position.

The processing device 150 may repeat the first or second calculation method regardless of whether or not the task is being performed. Specifically, the processing device 150 uses multiple positions of the hand obtained in a prescribed duration to perform the first or second calculation method. When it is not estimated that the task is being performed based on the multiple positions of the hand in the duration, the processing device 150 slides the duration and re-performs the first or second calculation method. As an example, the duration is set to 6 seconds; and the slide amount is set to 16 milliseconds. The duration and the slide amount are appropriately set according to the performance of the processing device 150.

When the task is not being performed, the tool does not actually rotate, and there is no center of rotation. However, an apparent center position can be calculated based on multiple positions of the hand. While the task is not being performed, the calculated center position is separated from the positions of the fastening locations. It is therefore not estimated that the task is being performed. When the task is performed, the calculated center position approaches the position of the fastening location. The processing device 150 estimates the timing at which the task is initially estimated to be performed to be the start of the task.

For example, when the task is estimated at one of the fastening locations, the display device 100a and the display device 100b transmit the estimation result to the terminal device 100c or the terminal device 100d. Based on the estimation result, the terminal device 100c or the terminal device 100d may associate the record of the task with data of the estimated fastening location. The record of the task indicates that the screw is turned at the fastening location. The task record is automatically generated thereby.

When a digital tool such as a digital torque wrench, a digital torque driver, or the like is used, the processing device 150 receives the detected torque value from the tool. The torque value necessary for the fastening may be preset, and the digital tool may determine whether or not the necessary torque value is detected. The digital tool transmits the determination result to the processing device 150. The digital tool also transmits the rotation angle, the time at which the torque value was detected, etc., to the processing device 150.

The display device 100a and the display device 100b transmit the data received from the digital tools respectively to the terminal devices 100c and 100d. The terminal device 100c and the terminal device 100d associate the determination result or the maximum received torque value with data of the task location. A more detailed task record is automatically generated thereby.

Based on the received torque value, the processing device 150 may determine whether or not the estimated task at the fastening location has ended. When the received torque value is not less than a preset torque value, the processing device 150 determines that the task at the fastening location has ended. When a determination result indicating whether or not the necessary torque value is detected is received from the tool, the processing device 150 may determine whether or not the task at the fastening location has ended based on the determination result.

When the end of the task is determined, the display device 100a and the display device 100b transmit the determination result to the terminal device 100c or the terminal device 100d. When the determination result is received, the terminal device 100c or the terminal device 100d associate the record of the task with the data of the estimated fastening location.

When the screw is tightened multiple times at one fastening location, the processing device 150 may count the number of times that the screw is tightened. The count of the screw-tightening is incremented when it is determined that the task has ended after it is estimated that the task is being performed.

The virtual object 411x, the virtual object 411y, or the virtual object 411z may be displayed in addition to the virtual object 411. When the virtual object 411x or the virtual object 411y are displayed, the virtual object 411 may be displayed after the task at the fastening location 211 is estimated. The virtual object 411 includes information of the task. Therefore, the size of the virtual object 411 is greater than the size of the virtual object 411x or the virtual object 411y. The large virtual object 411 easily overlaps the article 200. When the virtual object 411 overlaps the article 200, it is difficult for the worker to visually recognize the article 200. By displaying the virtual object 411 after the start of the task, the display of the virtual object 411 does not easily obstruct the task. The convenience of the display device 100 can be further improved.

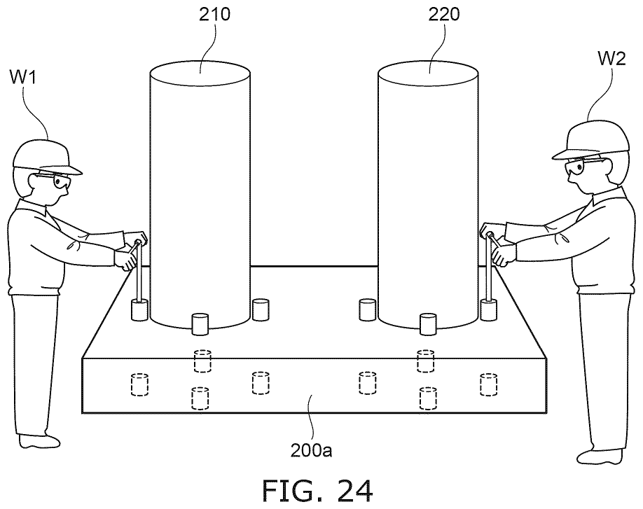

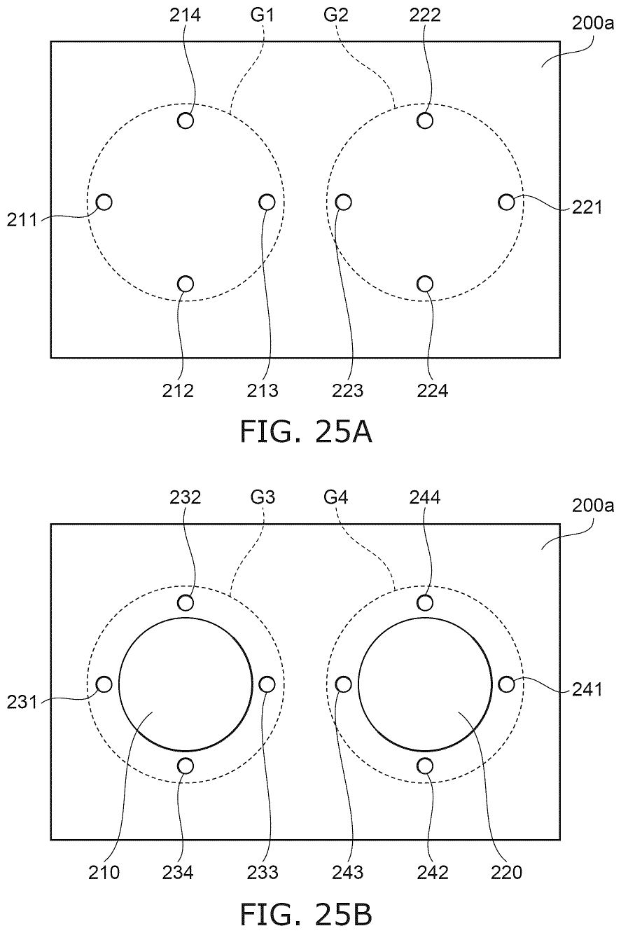

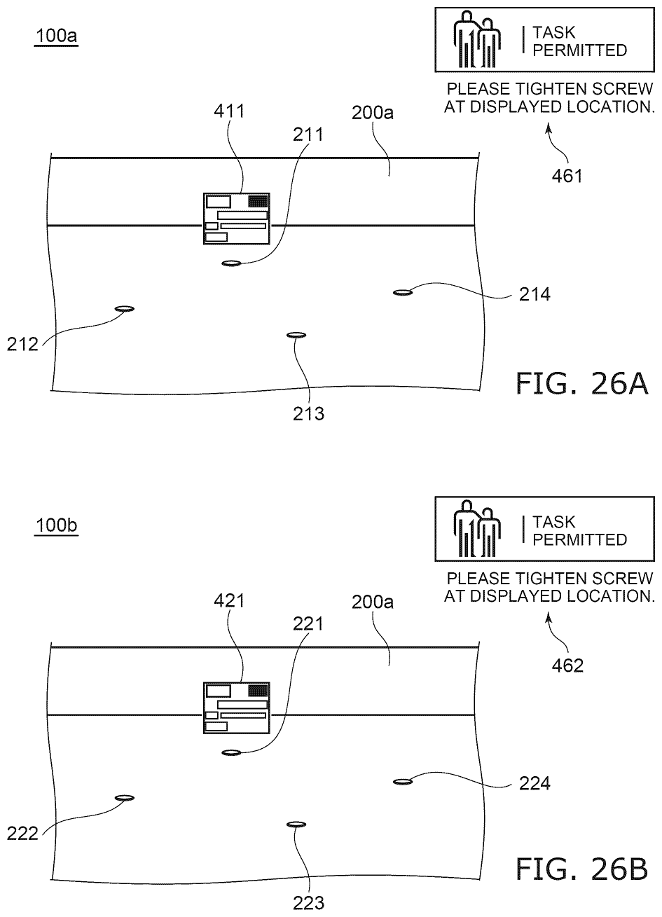

FIG. 24 is a schematic view illustrating a task. FIG. 25A is a bottom view showing the article on which the task is performed. FIG. 25B is a plan view showing the article on which the task is performed. FIGS. 26A, 26B, 27A, 27B, 28A, and 28B are schematic views showing output examples of the display device according to the embodiment.

Other than the article 200 shown in FIGS. 3 and 4, a task may be performed on an article 200a shown in FIG. 24. The workers W1 and W2 perform the task at the fastening locations of the article 200a. The cylindrical member 210 and the cylindrical member 220 are placed on the article 200a.

The fastening locations are present at the lower surface and upper surface of the article 200a. As shown in FIG. 25A, the fastening locations 211 to 214 and the fastening locations 221 to 224 are present at the lower surface of the article 200a. As shown in FIG. 25B, the fastening locations 231 to 234 and fastening locations 241 to 244 are present at the upper surface of the article 200a.

The fastening locations 231 to 234 are positioned around the member 210. The fastening locations 211 to 214 are positioned directly under the fastening locations 231 to 234. The fastening locations 211 to 214 and 231 to 234 are provided to fix the member 210.

The fastening locations 241 to 244 are positioned around the member 220. The fastening locations 221 to 224 are, respectively, positioned directly under the fastening locations 241 to 244. The fastening locations 221 to 224 and 241 to 244 are provided to fix the member 220.

When the task is performed, the host computer 100e acquires the fastening location master data. For example, as shown in FIGS. 25A and 25B, the fastening locations 211 to 214, the fastening locations 221 to 224, the fastening locations 231 to 234, and the fastening locations 241 to 244 are assigned respectively to the first group G1, the second group G2, the third group G3, and a fourth group G4.

The fastening location master data may include the task rank of the groups. As an example, the task of the first and second groups G1 and G2 is performed before the task of the third and fourth groups G3 and G4. The first group G1 is assigned to the display device 100a (the worker W1); and the second group G2 is assigned to the display device 100b (the worker W2). The worker W1 is determined to perform the task at the fastening location 211. The worker W2 is determined to perform the task at the fastening location 221.

First, the workers W1 and W2 move under the article 200a and perform the task at the fastening locations 211 and 221 while looking upward. At this time, as shown in FIG. 26A, the display device 100a displays the virtual object 411 at the fastening location 211. As shown in FIG. 26B, the display device 100b displays the virtual object 421 at the fastening location 221.

As shown in FIGS. 26A and 26B, the display devices 100a and 100b may display messages 461 and 462 respectively for the workers W1 and W2. The messages 461 and 462 respectively are instructions of the task to the workers W1 and W2.

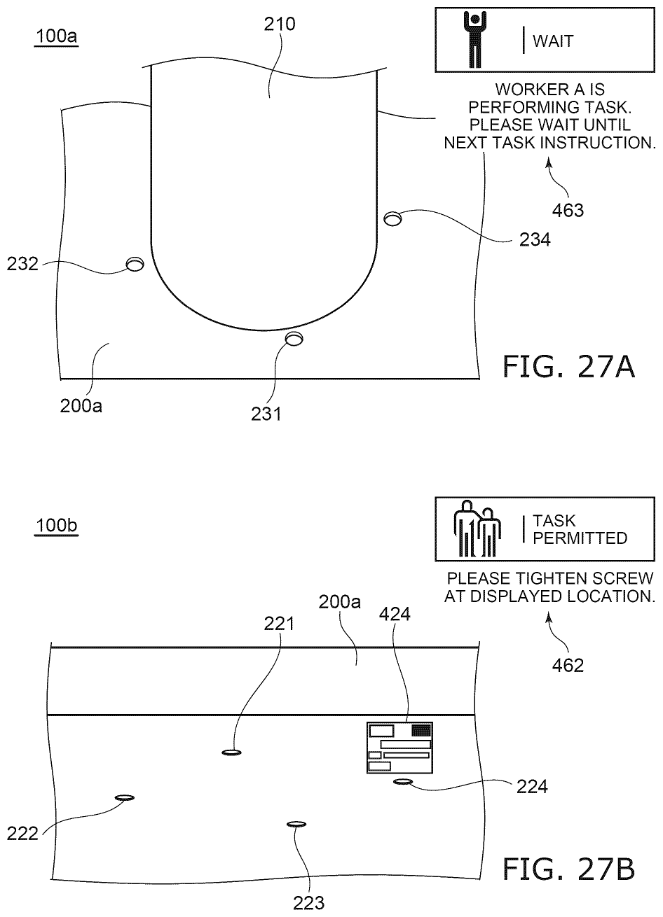

For example, the worker W1 finishes the task earlier than the worker W2. In such a case, the host computer 100e assigns the task at the fastening locations of the third group G3 to the display device 100a. However, it is necessary to perform the task of the third group G3 after the task has ended for both the first and second groups G1 and G2. The worker W1 must wait until the task of the worker W2 has ended. In such a case, as shown in FIG. 27A, the display device 100a may display a message 463. The message 463 is a wait instruction to the worker W1.

While the worker W1 is waiting, the worker W2 performs the task on the second group G2. FIG. 27B shows a display example when the task at the fastening locations 221 to 223 has ended, and the worker W2 is performing the task at the fastening location 224. The virtual object 424 is displayed at the fastening location 224.

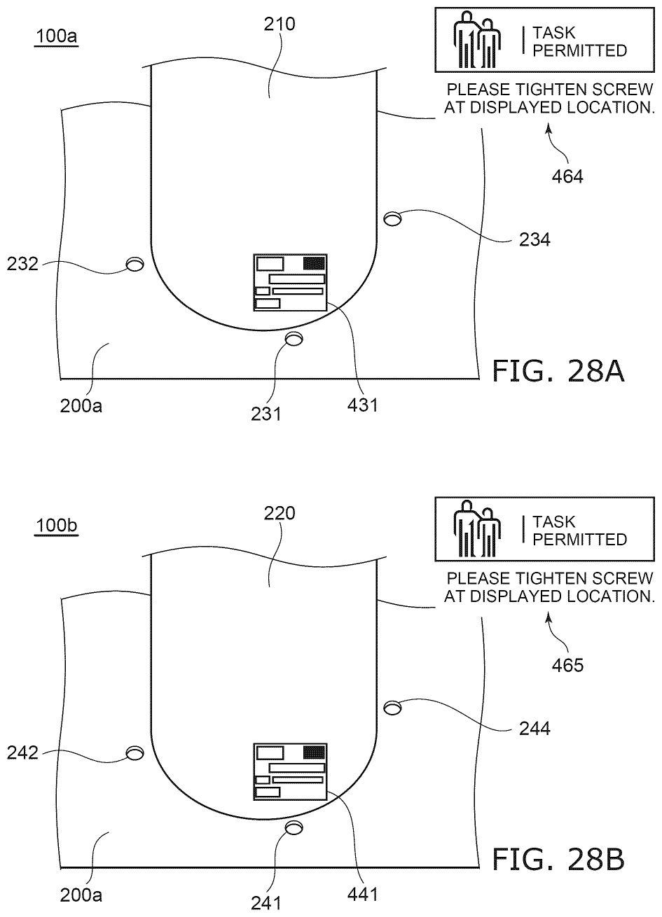

Subsequently, when the task on the second group G2 by the worker W2 has ended, the worker W1 can start the task on the third group G3. For example, as shown in FIG. 28A, the virtual object 431 is displayed at the fastening location 231. The task of the fourth group G4 is assigned to the worker W2. As shown in FIG. 28B, a virtual object 441 is displayed at the fastening location 241.

Because the task of the worker W1 is permitted, the message 463 changes to a message 464 as shown in FIG. 28A. The message 464 is an instruction of the task to the worker W1. The display device 100b displays a message 465 of an instruction of the task to the worker W2.

In the examples shown in FIGS. 26A to 28B, the instruction may be output using a voice instead of the message or in addition to the message.

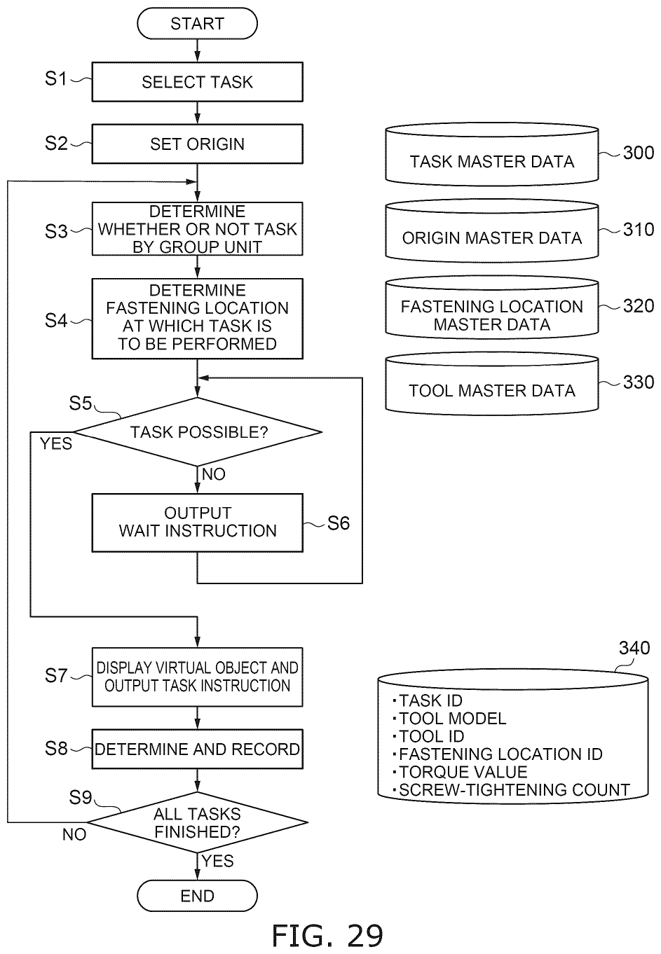

FIG. 29 is a flowchart showing a task support method according to the embodiment.

When the task support method shown in FIG. 29 is performed, the various master data shown in FIG. 7 is referenced as appropriate. First, the task to be performed is selected (step S1). For example, the terminal device 100c, the terminal device 100d, or the host computer 100e accepts the selection of the task. The task to be performed is selected by the worker or the manager of the task selecting the task ID or the article ID. The terminal device 100c, the terminal device 100d, or the host computer 100e may determine the task to be performed based on data obtained from the image camera 131 or another sensor. The terminal device 100c, the terminal device 100d, or the host computer 100e select the task based on the determination result.

Then, the image camera 131 images the marker 205. The processing device 150 sets the origin of the three-dimensional coordinate system by using the position and orientation of the marker 205 as a reference (step S2).

The host computer 100e refers to the fastening location master data 320 and determines whether or not the task is performed by group unit (step S3). For example, it is determined that the task must be performed by group unit when the sequence of the task for the fastening locations is set by segment or group in the fastening location master data 320. When the sequence of the task is not specified in the fastening location master data 320, it is determined that it is unnecessary to perform the task by group unit. The host computer 100e transmits the fastening location master data 320 and the result of the determination to the terminal devices 100c and 100d.

The terminal devices 100c and 100d determine the fastening location at which the task is to be performed based on the determination result of step S3 (step S4). When the task is performed by group unit, the fastening location at which the task is to be performed is determined according to the sequence within the group. When the sequence of the task between groups is set, such a sequence also is referenced to determine the fastening location. When the task is not performed by group unit, the fastening location that is most proximate to the display device 100 is determined as the fastening location at which the task is performed.

The terminal devices 100c and 100d determine whether or not the task can be performed at the determined fastening location (step S5). The terminal devices 100c and 100d transmit the determination result respectively to the display devices 100a and 100b. For example, the task is determined not to be possible when waiting for the necessary completion of the task of another group. In such a case, the processing device 150 outputs a wait instruction to the worker (step S6). The wait instruction may be displayed as a message, or may be output as a voice. Subsequently, step S5 is re-performed, and it is re-determined whether or not the task is possible.

When the task at the determined fastening location can be performed in parallel with the task of another group, or when it is unnecessary for the task to wait for the completion of the task of the other group, the processing device 150 displays a virtual object at the fastening location and outputs an instruction of the task to the worker (step S7). The fastening location master data 320 and the tool master data 330 are referenced when displaying the virtual object and determining the performing of the task. The instruction of the task may be displayed as a message, or may be output as a voice. The processing device 150 determines whether or not the task was performed for the fastening location determined in step S4. When it is determined that the task was performed, the terminal device 100c or 100d generates the record of the task for the fastening location for which the task was estimated to have been performed (step S8).

The record that is generated in step S8 is stored in history data 340. For example, the torque value that is detected by the tool is associated with the ID of the task and the ID of the estimated fastening location. As illustrated, the processing device 150 also may associate the model and ID of the tool used, the screw-tightening count, and the recognition result of the mark with the ID of the fastening location. The mark is recognized by the processing device 150 based on the image that is imaged by the image camera 131. The processing device 150 extracts an aggregate of pixels of the mark color from the image and counts the number of pixels in the aggregate. When the number of pixels is greater than a preset threshold, a mark is determined to be present.

After step S8, the processing device 150 determines whether or not all of the tasks have ended (step S9). When not all of the tasks have ended, step S3 is re-performed. For example, when the task is performed for the fastening location included in one group in the directly-previous step S4 and there is still a fastening location in the group for which the task is not performed, the task is determined for the fastening location for which the task still is not performed in the next steps S3 and S4. As a result, the task is repeated as appropriate by group unit.

Advantages of the embodiment will now be described.

For a large article, there are cases where the multiple workers perform the task together. Conventionally, the workers perform the task while communicating with each other about which fastening locations to perform the task on. However, the mutual confirmation of the task requires time and reduces the efficiency of the task. Also, it may be difficult for the workers to communicate with each other when the workers are separated from each other, the workplace is noisy, etc. As a result, there is a possibility that the task may be performed in an erroneous sequence, the task may be performed multiple times at one fastening location, or a fastening location may occur for which the task is not performed.

The embodiment of the invention is used to support a task performed by multiple workers. The task support system 1 includes the multiple display devices 100. Each worker performs the task by wearing the display device 100. The display device 100 is configured to display a virtual object to overlap real space. By the display of the virtual object, the worker can ascertain the fastening location at which the task is to be performed, or can confirm information of the task based on the virtual object. As a result, the efficiency of the task can be increased.

When the task is performed, fastening location master data related to the multiple fastening locations is acquired. In the fastening location master data, each fastening location is assigned to one of the multiple groups. When the fastening location master data is acquired, for example, the display device 100a displays the virtual object 411 at the fastening location 211 included in the first group G1 as shown in FIG. 9A. The display device 100b displays the virtual object 421 at the fastening location 221 included in the second group G2 as shown in FIG. 9B.

In other words, the display devices display virtual objects at fastening locations of mutually-different groups. Accordingly, the task can be prevented from being unintentionally performed multiple times at one fastening location. By displaying the virtual objects according to a preset sequence, the worker can be prompted to perform the task in accordance with the sequence by group. Therefore, the task can be prevented from being performed in an erroneous sequence. Also, the likelihood of fastening locations for which the task is not performed can be reduced.

According to embodiments of the invention, a task performed by multiple workers can be supported.

The display device 100 can use the position of the hand of the wearer to estimate the task for each fastening location. For example, the display device 100a repeatedly measures the position of the hand of the worker W1. The display device 100a estimates the task at the fastening location 211 based on the contact between the hand and a virtual object or based on the movement of the hand. The display device 100b repeatedly measures the position of the hand of the worker W2. The display device 100b estimates the task at the fastening location 221 based on the contact between the hand and a virtual object or based on the movement of the hand.

When the task is estimated, a task record that indicates whether or not the task is performed at each fastening location can be automatically generated. It is therefore unnecessary for the worker to generate the task record. The efficiency of the task can be further improved. Based on the task record, the fastening locations at which the task has been performed and the fastening locations at which the task still has not been performed can be discriminated. Based on the discrimination result and the preset sequence, the fastening locations at which the task needs to be performed can be determined, and the virtual objects can be displayed at the fastening locations.

When one of the worker W1 or W2 finishes the task of the assigned group, the task of the next group is assigned to the worker W1 or W2. In the examples shown in FIGS. 10A to 12B, when the worker W1 has finished the task of the first group G1 and the worker W2 has not finished the task of the second group G2, the task of the third group G3 is assigned to the worker W1. As shown in FIG. 12A, the display device 100a displays the virtual object 431 at the fastening location 231 of the third group G3. By assigning the next task to the worker having the faster task speed, the entire task can be finished more quickly.

According to the task, there are cases where one worker must wait for another worker. For example, for the article 200a shown in FIG. 24, the task at the fastening locations 231 to 234 and 241 to 244 at the upper surface cannot be performed if the task at the fastening locations 211 to 214 and 221 to 224 at the lower surface is incomplete. For example, the worker W1 performs the task at the fastening locations 211 to 214; and the worker W2 performs the task at the fastening locations 221 to 224. When the task of the worker W1 has ended earlier than the task of the worker W2, the worker W1 must wait for the end of the task of the worker W2. Rework of the task becomes necessary when the worker W1 turns a screw at a fastening location at the upper surface of the article 200a before the end of the task of the worker W2. In such a case, the screw at the fastening location at which the task has been performed is returned to the original state; and the task is re-performed after the task of the worker W2 has ended.

For this problem, the display device 100 determines whether or not the task can be performed in parallel for the fastening locations. In the example above, the worker W1 has finished the task at the fastening locations 211 to 214. The worker W1 has ample time to perform the task at the fastening locations 231 to 234. However, it is necessary to perform the task at the fastening locations 231 to 234 after the task at the fastening locations 221 to 224 has ended. Therefore, the display device 100a determines that the task at the fastening locations 231 to 234 cannot be performed in parallel with the task at the fastening locations 221 to 224. In such a case, the wait instruction (the message 463) is output as shown in FIG. 27A. As a result, the worker can be prompted to perform a more appropriate task.

When the sequence of the task for the fastening locations is not specified, the display device 100a and the display device 100b display virtual objects at the most proximate fastening locations for which the task still is not performed. As a result, the time and effort of the worker moving can be reduced, and the efficiency of the task can be increased.

For example, when the sequence of a second task is not specified after a first task has been performed at the fastening locations, the display device 100a and the display device 100b display virtual objects at most proximate fastening locations for which the second task has not been performed.

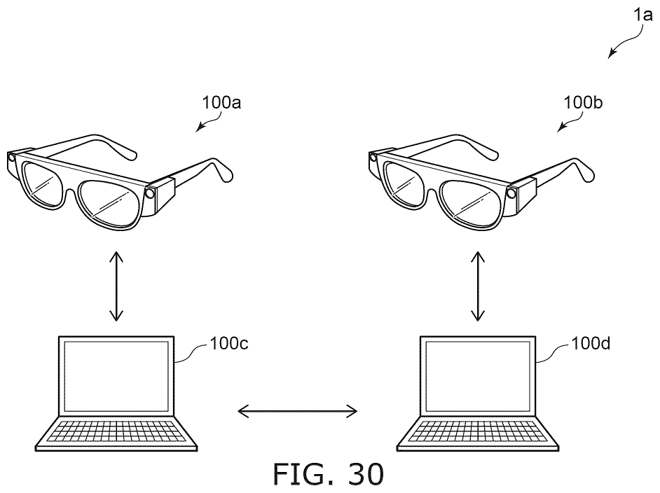

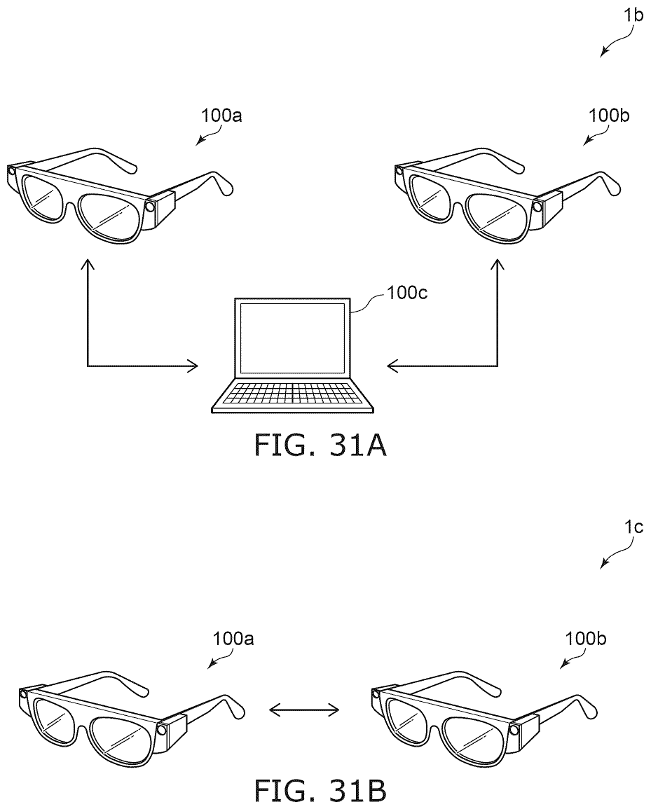

FIGS. 30, 31A, and 31B are schematic views showing configurations of other task support systems according to the embodiment.

The configuration of the task support system 1 according to the embodiment is not limited to the example shown in FIG. 1. As in a task support system 1a shown in FIG. 30A, the host computer 100e may be omitted. In such a case, the terminal device 100c or 100d includes the function as the host computer 100e.

As in a task support system 1b shown in FIG. 31A, the terminal device 100d and the host computer 100e may be omitted. In such a case, the terminal device 100c includes the functions of the terminal device 100d and the host computer 100e and is connected with both the display devices 100a and 100b. As in a task support system 1c shown in FIG. 31B, the terminal device 100c, the terminal device 100d, and the host computer 100e may be omitted. In such a case, the display devices 100a and 100b respectively include the functions of the terminal devices 100c and 100d. One of the display device 100a or 100b includes the function of the host computer 100e.

For example, the display device 100 is an AR device that displays augmented reality (AR), or a MR device that displays mixed reality (MR). When the display device 100 is realized as a MR device, contact between a virtual object and a human body can be detected. Accordingly, it is favorable for the display device 100 to be a MR device when detecting the contact between the prescribed object and the virtual object as shown in FIGS. 17A and 17B.

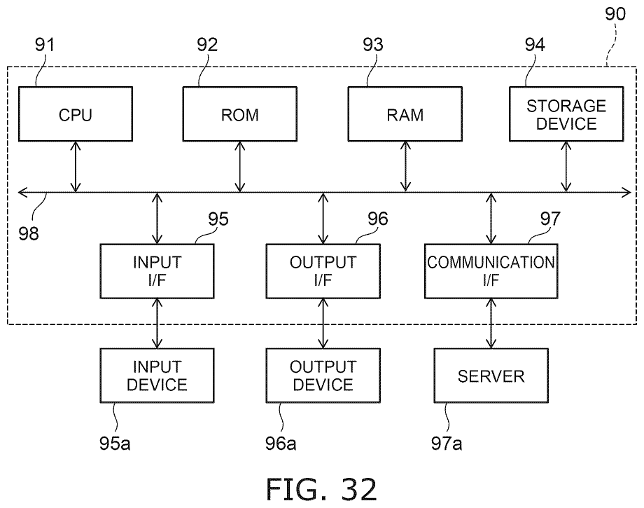

FIG. 32 is a schematic view showing a hardware configuration.

For example, a computer 90 shown in FIG. 32 is used as the processing device 150, the terminal device 100c, the terminal device 100d, and the host computer 100e of the display device 100. The computer 90 includes a CPU 91, ROM 92, RAM 93, a storage device 94, an input interface 95, an output interface 96, and a communication interface 97.

The ROM 92 stores programs controlling operations of the computer 90. The ROM 92 stores programs necessary for causing the computer 90 to realize the processing described above. The RAM 93 functions as a memory region into which the programs stored in the ROM 92 are loaded.

The CPU 91 includes a processing circuit. The CPU 91 uses the RAM 93 as work memory and executes the programs stored in at least one of the ROM 92 or the storage device 94. When executing the programs, the CPU 91 executes various processing by controlling configurations via a system bus 98.

The storage device 94 stores data necessary for executing the programs and/or data obtained by executing the programs. The storage device 94 includes a solid state drive (SSD), etc.

The input interface (I/F) 95 can connect the computer 90 with an input device. The CPU 91 can read various data from the input device via the input I/F 95.

The output interface (I/F) 96 can connect the computer 90 and an output device. The CPU 91 can output data to the output device via the output I/F 96.

The communication interface (I/F) 97 can connect the computer 90 and a device outside the computer 90. For example, the communication I/F 97 connects a digital tool and the computer 90 by Bluetooth (registered trademark) communication.

The data processing performed by the processing device 150 may be performed by only one computer 90. A part of the data processing may be performed by a server or the like via the communication I/F 97.

Processing of various types of data described above may be recorded, as a program that can be executed by a computer, on a magnetic disk (examples of which include a flexible disk and a hard disk), an optical disk (examples of which include a CD-ROM, a CD-R, a CD-RW, a DVD-ROM, a DVD+R, and DVD+RW), a semiconductor memory, or another non-transitory computer-readable storage medium.

For example, information recorded on a recording medium can be read by a computer (or an embedded system). The recording medium can have any record format (storage format). For example, the computer reads a program from the recording medium and causes the CPU to execute instructions described in the program, on the basis of the program. The computer may obtain (or read) the program through a network.

Embodiments of the invention include the following features.

### Feature 1

A task support system configured to support a task for a plurality of fastening locations of an article present in a real space, the task support system including:
a first display device and a second display device configured to display virtual objects to overlap the real space,
each of the plurality of fastening locations being assigned to one of a plurality of groups,
the first display device displaying a first virtual object for a first fastening location included in a first group, the first group being one of the plurality of groups,
the second display device displaying a second virtual object for a second fastening location included in a second group, the second group being another one of the plurality of groups.

### Feature 2

The task support system according to feature 1, in which
the first display device estimates a task for the first fastening location by using a position of a hand of a wearer of the first display device, and
the second display device estimates a task for the second fastening location by using a position of a hand of a wearer of the second display device.

### Feature 3

The task support system according to feature 2, in which
when the task has been performed for all of one or more of the first fastening locations included in the first group, the first display device displays a third virtual object for a third fastening location included in a third group, and
the third group is another one of the plurality of groups.

### Feature 4

The task support system according to feature 2, in which
the first display device outputs a wait instruction when the task has been performed for all of one or more of the first fastening locations included in the first group and the task has not been performed for at least one among one or more of the second fastening locations included in the second group.

### Feature 5

The task support system according to any one of features 2 to 4, in which
when the task has been performed for all of the plurality of fastening locations, the first display device and the second display device each display a virtual object for a most proximate fastening location among the plurality of fastening locations.

### Feature 6

The task support system according to any one of features 1 to 5, in which
the first virtual object includes at least one selected from a specified torque value necessary for screw-tightening at the first fastening location, a torque value detected in the screw-tightening at the first fastening location, and a screw-tightening count at the first fastening location, and
the second virtual object includes at least one selected from a specified torque value necessary for screw-tightening at the second fastening location, a torque value detected in the screw-tightening at the second fastening location, and a screw-tightening count at the second fastening location.

### Feature 7

The task support system according to any one of features 1 to 6, in which
the first display device and the second display device set a three-dimensional coordinate system in a virtual space by using a marker located in the real space as an origin.

### Feature 8

A task support method, including:
supporting a task for a plurality of fastening locations of an article present in a real space;
assigning each of the plurality of fastening locations to one of a plurality of groups;
causing a first display device to display a first virtual object for a first fastening location included in a first group, the first display device being configured to display a virtual object to overlap the real space, the first group being one of the plurality of groups; and
causing a second display device to display a second virtual object for a second fastening location included in a second group, the second display device being configured to display a virtual object to overlap the real space, the second group being another one of the plurality of groups.

According to the embodiments above, a task support system and a task support method are provided in which a task performed by multiple workers can be supported.

In the specification, “or” shows that “at least one” of items listed in the sentence can be adopted.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the invention. Moreover, above-mentioned embodiments can be combined mutually and can be carried out.

What is claimed is:

1. A task support system configured to support a task for a plurality of fastening locations of an article present in a real space, the task support system comprising:
a first display device and a second display device configured to display virtual objects to overlap the real space,
each of the plurality of fastening locations being assigned to one of a plurality of groups,
the first display device displaying a first virtual object for a first fastening location included in a first group, the first group being one of the plurality of groups,
the second display device displaying a second virtual object for a second fastening location included in a second group, the second group being another one of the plurality of groups.

2. The task support system according to claim 1, wherein
the first display device estimates a task for the first fastening location by using a position of a hand of a wearer of the first display device, and
the second display device estimates a task for the second fastening location by using a position of a hand of a wearer of the second display device.

3. The task support system according to claim 2, wherein
when the task has been performed for all of one or more of the first fastening locations included in the first group, the first display device displays a third virtual object for a third fastening location included in a third group, and
the third group is another one of the plurality of groups.

4. The task support system according to claim 2, wherein
the first display device outputs a wait instruction when the task has been performed for all of one or more of the first fastening locations included in the first group and the task has not been performed for at least one among one or more of the second fastening locations included in the second group.

5. The task support system according to claim 2, wherein
when the task has been performed for all of the plurality of fastening locations, the first display device and the second display device each display a virtual object for a most proximate fastening location among the plurality of fastening locations.

6. The task support system according to claim 1, wherein
the first virtual object includes at least one selected from a specified torque value necessary for screw-tightening at the first fastening location, a torque value detected in the screw-tightening at the first fastening location, and a screw-tightening count at the first fastening location, and
the second virtual object includes at least one selected from a specified torque value necessary for screw-tightening at the second fastening location, a torque value detected in the screw-tightening at the second fastening location, and a screw-tightening count at the second fastening location.

7. The task support system according to claim 1, wherein
the first display device and the second display device set a three-dimensional coordinate system in a virtual space by using a marker located in the real space as an origin.

8. A task support method, comprising:
supporting a task for a plurality of fastening locations of an article present in a real space;
assigning each of the plurality of fastening locations to one of a plurality of groups;
causing a first display device to display a first virtual object for a first fastening location included in a first group, the first display device being configured to display a virtual object to overlap the real space, the first group being one of the plurality of groups; and
causing a second display device to display a second virtual object for a second fastening location included in a second group, the second display device being configured to display a virtual object to overlap the real space, the second group being another one of the plurality of groups.
